(19) United States
(12) Patent Application Publication
(10) Pub. No.: US 2014/0089826 A1
(43) Pub. Date: Mar. 27, 2014

(54) SYSTEM AND METHOD FOR A UNIVERSAL RESIDENT SCALABLE NAVIGATION AND CONTENT DISPLAY SYSTEM COMPATIBLE WITH ANY DIGITAL DEVICE USING SCALABLE TRANSPARENT ADAPTABLE RESIDENT INTERFACE DESIGN AND PICTO-OVERLAY INTERFACE ENHANCED TRANS-SNIP TECHNOLOGY

(71) Applicant: Ian A. R. Boyd, North Las Vegas, NV (US)

(72) Inventor: Ian A. R. Boyd, North Las Vegas, NV (US)

(21) Appl. No.: 13/904,025

(22) Filed: May 29, 2013

Related U.S. Application Data
(63) Continuation-in-part of application No. 13/829,196, filed on Mar. 14, 2013.
Application No. 13/829,196 is a continuation-in-part of application No. 13/829,838, filed on Mar. 14, 2013.
Application No. 13/829,838 is a continuation-in-part of application No. 13/830,513, filed on Mar. 14, 2013.
Application No. 13/830,513 is a continuation-in-part of application No. 13/830,210, filed on Mar. 14, 2013.
Application No. 13/830,210 is a continuation-in-part of application No. 13/902,957, filed on May 27, 2013.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.

(51) Int. Cl. G06F 3/0481

(52) U.S. Cl. CPC G06F 3/0481
USPC 715/765

(57) ABSTRACT

A software application system and method for building a common adaptable user interface that is universally compatible with any digital device. The software application is in a small file format that is rapidly downloaded with a Resident “CORE Application” and an emulation of a “Resident Server” on the digital device for immediate access and display using an adaptable Universal PictoOverlay Navigation Interface. The software application system uses modular adaptable and adapting code that provides scalable compatibility and functional adaptability across multiple digital devices such as any computer, cellular phone, smart phone, tablet or other digital device. The STAR-RAID-POINT Application platform can create computer and mobile applications, web sites, shopping carts and transactional management systems. STAR-RAID-POINT Applications also provide enhanced featured, displayable, narrated, musicked, Multi-Dimensional Presentations to dynamically present an informative, educational, factual, story, game, puzzle or other artistic creation in an evocative and emotive format.

### CROSS REFERENCE TO RELATED APPLICATIONS

This application claims the benefit of U.S. Provisional Application No. 61/705,686 filed Sep. 26, 2012 entitled SYSTEM AND METHOD FOR THE CREATION OF ENHANCED AUDIO VISUAL STORYBOARDS USING A LAYERED COMPOSITE IMAGE GENERATOR, U.S. Provisional Application No. 61/716,508 filed Oct. 20, 2012 entitled SYSTEM AND METHOD FOR THE CREATION OF AN ENHANCED MULTI-DIMENSIONAL PICTOGAME, U.S. Provisional Application No. 61/750,022 filed Jan. 8, 2013 entitled SYSTEM AND METHOD FOR THE CREATION OF AN E-ENHANCED MULTI-DIMENSIONAL PICTOKIDS PRESENTATION, and U.S. Provisional Application No. 61/763,749 filed Feb. 12, 2013 PAYMENT AND ACCOUNT MANAGEMENT SYSTEM USING PICTOOVERLAY TECHNOLOGY which are hereby incorporated herein by reference in their entireties. The application is further a continuation-in-part to U.S. application Ser. No. 13/829,196 filed Mar. 14, 2013 entitled SYSTEM AND METHOD FOR THE CREATION OF AN E-ENHANCED MULTI-DIMENSIONAL PICTOSTORY USING PICTOOVERLAY TECHNOLOGY, and a continuation-in-part to U.S. application Ser. No. 13/829,838 filed Mar. 14, 2013 entitled SYSTEM AND METHOD FOR THE CREATION OF AN ENHANCED MULTI-DIMENSIONAL PICTOGAME USING PICTOOVERLAY TECHNOLOGY, and a continuation-in-part to U.S. application Ser. No. 13/830,210 filed Mar. 14, 2013 entitled PAYMENT AND ACCOUNT MANAGEMENT SYSTEM USING PICTOOVERLAY TECHNOLOGY and is a continuation-in-part to U.S. application Ser. No. 13/830,513 filed Mar. 14, 2013 entitled SYSTEM AND METHOD FOR THE CREATION OF AN E-ENHANCED MULTI-DIMENSIONAL PICTOKIDS PRESENTATION USING PICTOOVERLAY TECHNOLOGY and is a continuation-in-part to U.S. application Ser. No. 13/902,957 filed May 27, 2013 entitled SYSTEM AND METHOD FOR THE CREATION OF AN E-ENHANCED MULTI-DIMENSIONAL PICTOFILM PRESENTATION USING PICTOOVERLAY INTERFACE ENHANCED TRANS-SNIP TECHNOLOGY which claims the benefit of U.S. Provisional Application No. 61/652,306 filed May 28, 2012 entitled AUDIO VIDEO FILM CREATOR FROM STORYLINE, CAST AND CONTEXT SETTINGS INPUT, which are hereby incorporated herein by reference in their entireties.

### FIELD OF THE INVENTION

The present invention relates to a software application development system and method for producing, delivering and displaying universally adaptable, scalable content and code that is compatibly displayable in “CORE Application” and “Dependant Applications” or other core content form, on all mobile devices irrespective of specifications and by all other computer processing display devices that have in common the ability to use a web-net browser and/or other application software such as an HTML viewer to display a web based page on HTML, CSS, JavaScript, or any of their versions. Specifically, the software methodology applies a scalable small file format that is rapidly downloaded to a digital device, with the intent of creating-emulating further applications or core content on a resident server for ease and speed of access. The Dependant Applications could exist on an external remote server and be accessible using the Core Application or preferably be stored within a Resident Server. The Core Application code and content could and would include a dedicated Web browser, a common adaptable Graphical User Navigation Launch Interface, Small File formats applicable to mobile devices, STAR-RAID-POINT (SRP) technologies, and exchangeable adaptable Content Based Modules. The CORE Application acts and performs as a standalone complete application not dependant on any other external systems for operation. The system is based on the Core Application and the replaceable-modifiable Dependant Applications or other Core Application content within the resident server where content/code can be added to, prioritized, replaced, expanded, contracted to change, and altered to modify the information and/or content to be displayed. This system methodology produces application code and content that is not dependent on Internet/Web access to display unspecified amounts of an applications functionality, the application being either web based or other application code and content.

This system is designed not only to cater to Web Based HTML code but is intended to apply to modification of resident native application code and content where the modular code/content concept and characteristics are also applied, and where linkage to HTML code is desirable or effective as separate resident packages. In native code applications, resident code would be modularized to allow additional or replaceable packets of content code to be delivered to modify/change the existing core and/or dependent applications' functionality, code and content.

The “software development and executable application” system uses adaptable and adapting code that provides scalable compatibility and functional adaptability across multiple digital devices such as any computer, cellular phone, iPhone, smart phone, iPad, tablet computer or other digital device. The application uses Scalable Transparent Adaptable Resident-Recordable Addable Interface Design (S.T.A.R.-R.A.I.D.) and PictoOverlay Interface Enhanced Trans-Snip (P.O.I.N.T.) Technology to dynamically present and provide for the creation of and access to numerous personal and commercial applications, including but not limited to adventure stories, games, puzzles, films, shopping and other interactive applications that are displayable at any resolution and in any format of any digital screen without utilizing software code that is specific to a particular device or format, meaning that the same code and content is utilized to interface with and display the STAR-RAID-POINT Application on any digital device. These applications may be downloaded to the resident server as dependant applications with a single core application for display and interaction with the digital device. All code and content for these applications is modular and therefore updates to code or content may be performed only within the core application; or only within the dependant application; with the capability to perform functional changes to either the core or dependant applications being dictated either by digital information embedded within the graphical content portion of a Trans-Snip or by other associated methods.

### BACKGROUND OF THE INVENTION

The concept of “Dependant Applications within a Resident Server” is not new. Arguably, it is nothing more than an additional folder and file structure that is resident on a digital device as opposed to available through a network or internet connection on an external remote server. However, the definition and addition of scalable STAR-RAID and POINT technology characteristics to this resident server folder structure are new to the art. A resident server provides ease and speed of access by reducing access time to continuously connect to and download from (sometimes numerous times) a remote server that dependent upon the quality and speed of the wired or wireless connection not only takes a tedious amount of time but also may be slow and intermittent in transmit speeds resulting in delays in viewing and accessing a web site or application. Access to the resident server using the STAR-RAID-POINT Application is immediate, (in fractions of seconds) with content displayable without delays aided by using the Small File Format and Trans-Snip Pictorial Overlay Technology.

Using the currently available digital technology relative to either personal or professional use, users access iPhones, smartphones, notebooks, netbooks, laptops, desktops, and tablet computers in numerous applications to develop, produce, and display content and code. With the exception of the workplace, and specifically in mobile applications, users primarily access the devices to search, shop, socialize, and send text messages, emails, images, and other information. Most of all these devices are also capable of making and receiving telephone calls, emails, and/or texting. Additionally, in the mobile smartphone world, these devices are also used almost for a third of the time for information, games, or self-gratification in other forms.

In the current state of software development an application or website may be limited to presentation on a single device, using either Responsive Technology and/or RESS Technology to resize the application or be redundantly coded in order to be displayed on other devices of different formats. These current approaches to translate an application to a number of different devices suffer from limitations in three specific areas, 1) Content Device Compatibility and Consistency; 2) Slow Download and Access Speed for Multiple Applications and Multiple Content versions; 3) Lack of Small File Format and Minimization of Code and Content with limited ability to change the resident code of the device. In using RESS to resize an application or website the content may not be easily scalable where minimization may cause image distortions or cause textual content to become illegible. In addition in most cases, in order to view a website on a small mobile device display, the user must also scroll to search for the content of interest and then zoom in to make the content legible.

As commonly experienced by a user in scrolling and zooming through a website, there are substantial delays as new content is downloaded and displayed with a somewhat annoying hourglass or refreshing arrow flashing for several seconds until the content is visible and accessible. Even with the fastest internet connections, dependent on the methods used to resize and translate an application or website the ease of access on a cellular phone or smartphone may be somewhat limited and frustrating for a user. Also importantly, in order to add new content or modify the content within an application or website requires additional coding and restructuring of the website layout to properly size and view the new content which may require the downloading of a completely new version of an application or temporary downtime as a website is updated. Overwriting an older application with a new version as well presents significant issues for a software developer to create code to convert data and templates from an older version to new file structures in a newer version without loss of data or formatting. The software developer as well must consider and redundantly code these conversions for data and templates stored in various digital device formats. Software applications of the current art therefore without additional coding and resizing are not adaptable, compatible, or modular and do not provide a format that may be universally displayed on any digital device.

The STAR-RAID-POINT Application system addresses and resolves each of these issues and limitations through a unique approach by providing a Universal PictoOverlay Interface and scalable resident server technology that may be used to format and develop any application or website. The STAR-RAID-POINT Application as well provides innovative applications and features to create and interact with dynamic fun and educational games and presentations.

### SUMMARY OF THE INVENTION

The software application development system and method of the present invention provides for the development of universally adaptable, scalable content and code that is compatibly displayable in “CORE Application” and “Dependant Applications or other CORE Application Content within the Resident Server” form on any digital device. The STAR-RAID-POINT Application system (SRP) of the present invention requires limited or no special or native individual coding that is specific to a particular digital device or display format. The present invention further provides that vibrant graphics and textual content conform to a prescribed number of device characteristics to properly clearly display and be immediately accessible. Specific features of the STAR-RAID-POINT Application system include PictoOverlay Trans-Snip Technology, the adaptable Universal PictoOverlay Navigation Interface, Dependant Applications within the Resident Server Swap Technology, and resident scalable adaptable Variable Content with Associated Encrypted Code changes, including STAR-RAID-POINT.

### Content Device Compatibility and Consistency

Based on current application technology, in order to be compatible with the display on multiple devices such as a small screen cellular phone, an iPhone device, an Android device, a tablet computer, a laptop, and a high definition video monitor, the developer either requires extensive time and resources to translate and write specific code that will provide for a website or software application to be properly sized and be displayed on each of these various formats, or the developer must use existing methodology such as either Responsive Technology and/or RESS Technology to fit the display to the device by compromising the “look” by squeezing or redacting the content on the device. A simple pull down menu may display a complete list of options for items to select on a larger format screen but be impossible to see or require excessive scrolling both down and to the left and right to view all of the items on a smaller format screen. Text within the display or the selection tab may be so small, that a User cannot distinguish what an item is or properly select an item unless a software developer has rewritten and modified the software code to resize and reformat the display to be presented on the smaller, low resolution digital display.

### Key STAR-RAID-POINT Characteristics

The characteristics of any digital device include and depend on 1) the Physical Screen Size, normally presented as the diagonal distance across the physical screen of the device; 2) the Aspect Ratio that is defined as 1.777 in a 16×9 format for HD and 1.33 for lower resolution digital screens in a 4×3 format; 3) the Pixel Density; 4) the provided content Image Resolution with 1024×768 being the current Quasi-standard for any web based application; 5) the Orientation decision of the screen; and 6) the SCROLL-ZOOM functionality of the Screen which contrasts with PAGE DRIVEN functionality, 7) the combination of image based and text based content and scalability requirements of each.

Importantly, on any device a ‘Lead’ or Main screen presents a full screen image at the resolution and characteristics associated with the digital device. As a software coder or developer of the prior art, the developer must adapt and translate code developed on one digital device format having a certain set of display characteristics to another device format having another set of characteristics to properly display a website or another software application. The STAR-RAID-POINT Application, in contrast to applications that develop code for each specific device, uses the PictoOverlay Technology with universal code that is compatible with any cellular phone, smartphone, computer system, tablet or other digital device. The compatibility of the STAR-RAID-POINT Application to any digital device is based on setting predetermined characteristics of the code, the structure, the content and the functionality of the application to adapt to characteristics of the digital device.

This innovative approach identifies the resolution and full screen settings of the digital device and automatically resizes to present compatible pages to these settings displaying the STAR-RAID-POINT content at the full screen size of the digital device without the requirement for additional coding or translating code to be compatible with all digital display formats. The STAR-RAID-POINT Application captures the resolution and full screen size specifications from the lead page of the device. This technique is very different from either the current Responsive Technology or RESS Technology for application design and web development where these approaches to transfer a screen display from one device to another is done by shrinking the size or parts of the screen or the image, or redacting portions and refitting content or text, or by requiring scrolling or zooming to properly view an image on different devices, with the translation to any device requiring additional specific coding for that device.

It is important to note, at this stage, that STAR-RAID-POINT Applications clearly differentiate between IMAGE TEXT (Raster) and TEXT TEXT (Font Driven) based content. The STAR-RAID-POINT Applications separate and transform content that may be images, image text or Font Driven text into scalable graphics formats using the PictoOverlay Trans-Snip Technology. This important structural separation and transformation of content provides for modularity of the application where content in the PictoOverlay Trans-Snip Technology format is scalable in for example Landscape orientation that may display in Page Driven Full Screen format to match the characteristics of any digital display without developing code specific to any digital device. In contrast, current Responsive Technology or RESS Technology must resize and scale each image object or text object separately to properly display on digital devices of different display characteristics. The STAR-RAID-POINT application further provides capability with a Font Driven Text Interface feature to display and print text in standard portrait display orientation and printer formats. This separate feature is provided to accept and present when needed primarily Font Driven Text based content such as Lists, E mail, Word documents, etc.

The STAR-RAID-POINT content in PictoOverlay Technology format is therefore adaptable to and shown completely on a digital device in full screen removing any requirement to scroll to properly view a larger image and text on a smaller screen or zoom to properly view a smaller image and clearly read text on a larger screen. The identical STAR-RAID-POINT content may therefore be displayed in full screen on a large high definition (HD) video monitor having an aspect ratio of 1.777 or on a small cellular phone screen display having an aspect ratio of 1.333 with the same clarity in visual content so that text and images are easily viewed at the proper image resolution. The STAR-RAID-POINT Application deals with 4:3 screen aspect ratios (1.333) by separating the standard HD display into 2 components, a Main Panel and a Side Control Panel with the Main Panel comprising 1024 by 768 image resolution and the side panel comprising 340 by 768 resolution thereby resulting in a combination which produces a high definition (HD) 1368 by 768 (16:9) resolution. In displays with aspect ratios of 4:3 only the 1024×768 Main Panel having the web resolution standard is displayed. The Side Control Panel is available through an optional hide-show capability which when selected is rescaled to be shown as an overlay on the Main Panel at the discretion of the user, thus maintaining compatibility with the resolution compatible with the digital device.

The STAR-RAID-POINT Application display is further consistently presented in a Landscape Page Layout in Full Screen at an Aspect Ratio of either 4:3 or 16:9 and that requires no scrolling down or across a page or menu, and no zooming of a portion of the display (as commonly found in MS Windows applications) to make it visible on smaller formats. The STAR-RAID-POINT Application allows for a universal image to be able to fit the native size of the device screen which may be at the standard web page resolution of 1024 by 768 or the standard HD resolution of 1368 by 768. The PictoOverlay content within the STAR-RAID-POINT application is adequately sized and effortlessly visible by a user using the smallest format screen on a cellular phone or a large format high definition video monitor.

It is also important to note, that the STAR-RAID-POINT Applications take advantage of the common feature of the device resolution settings with regard to PRINT functionality and sending a display as an EMAIL or EMAIL attachment in a standardized format. Within any STAR-RAID-POINT Application all PRINT functions are designed to print or send only the Main Panel display in its entirety. Uniquely, this PRINT functionality is sized in the 1024 by 768 resolution format that is designed to be printed only in a landscape orientation allowing the consistent fit required for printing a full page in a standard letter format 8½″ by 11″ printed page. The standardized size in formatting also provides for a consistent display within an EMAIL server application or as an EMAIL attachment as an image file in a number of graphic formats. Current website design constructs pages in a portrait format that does not commonly fit to a standard page size for printing or displaying appropriately within an EMAIL or image file as an EMAIL attachment. Therefore, selecting to print a page from the website may result in a number of pages being printed that spread content unevenly across two or more pages with little option for the user to easily select specifically the content that they wish to be printed. The compatibility of the STAR-RAID-POINT Application to a standard printing/file format allows for a user to choose and display content within the display and enlarge the content to be Full Screen within the Main Panel to print or attach the displayed content in its entirety. The application also provides for single or multiple layers of content to be displayed Full Screen, set as an attachment or for printing and by selecting a single button sending the Main Panel display content to a printer or an email application on the digital device.

### STAR-RAID-POINT Resident Server

### Ease and Speed of Access for Multiple Applications and Multiple Content Versions

Using Responsive Technology, RESS Technology or other prior art development applications, the applicable code for a specific format or device may further require initial downloading to the device, followed by regular server access and further downloading, a process that may take several seconds or minutes where the user must wait before being able to access the application. The application may further require the wired or wireless internet connection of the device to an external server at all times to have the software application operate properly on the device. While some software applications load executable code on a digital device, few programs are limited enough in size and memory requirements to construct a server that is resident and accessible on for example a mobile device with small storage capacity. The access and management of data directly on the device is another innovative feature of the STAR-RAID-POINT Application.

The SRP Core Application and SRP Dependant Applications are downloaded to the digital device and use an adaptable Resident Server to dramatically increase access speeds and remove delays resulting from the intermittent downloading of large format content from an external server through a wired or wireless internet connection. Any user of a smartphone has experienced the delays associated with accessing a web page, and waiting for a number of seconds for the page to display and be accessible. The STAR-RAID-POINT Core Application of the present invention downloads from the STAR-RAID-POINT Remote Server as one bulk data set to a digital device in relatively quicker time and at high speed rather than conventional applications that make multiple trips to a web server to pick up small amounts of data content. The bulk data set or SRP packet constructs the resident SRP Core Application and one or more SRP Dependant Applications within the Resident Server. The SRP Core Application contains code and content and performs higher level administrative functions to control and connect to the SRP Remote Server or another remote server. The SRP Core Application is also available to change portions of the native code of an application. In this way, the SRP Core Application code is applied to and functioned by existing core code on the device that normally provides an ability to display Web Pages, HTML, CSS, Java Script, or other applications.

By constructing a resident server on the device and storing the Dependant Applications within the Resident Server, the STAR-RAID-POINT Application minimally taxes the system resources and power usage because code, images and application content are already downloaded and available on the device so resources are used simply to display content not connect to an external server and perform the transmission of data. In applications of the prior art, this external server data may further be in large file formats that take a number of seconds to load on smaller storage and low memory devices. By creating the SRP Resident Core Application and SRP Dependant Applications within the Resident Server, the application code uses minimal system resources and access to SRP Content for the application within the resident server is immediate. The user is not left waiting for the software application to access an external remote server and download additional data and information.

The Dependant Applications within the Resident Server include the Data Store Resource for storing Trans-Snips, Enhancements and other SRP Content within an Encrypted Coordinate File Naming System. This SRP Content may be used in one or more STAR-RAID-POINT software applications. Additionally, the SRP Content within the bulk download is in Small File Format more applicable to the mobile device thereby reducing size, speed of download and speed of access on the device. The SRP Core Application and Dependant Applications within the Resident Server emulate a web server or other cloud server, and, includes both content and code available to the native application to not only change the immediate content of the application, but also to copy, replace or add content from an external server through downloading a new or modified SRP Packet to the Core Application and Dependant Application within the Resident Server. While the resident SRP Core Application and the resident SRP Dependant Application(s) may have different levels of changeability or restrictions such as administrative controls for certain portions of the core code, the modularity of the STAR-RAID-POINT Application provides for the SRP Core Application Code to be modified or to be untouched as additional applications or content are downloaded to one or more SRP Dependant Applications within the Resident Server. In this way the SRP Dependant Application gets packets with new information without changing the code of the SRP Core Application and therefore there is not a requirement to convert or translate new content to have the content display properly in Landscape Page Driven Full Screen on the digital device. The varying content results in multiple resident SRP Dependant Applications with different application features, code and content operational with one SRP Core Application.

The SRP Core application and its SRP Dependant Applications both contain Code and Content with at least one or more portions of such code and content being variable code and variable content and, with the SRP Core Application having the functionality to access the SRP Dependent Application for further replaceable code/content. All code and content is developed using PictoOverlay Trans-Snip Technology and being variable provides for separate SRP Dependant Application module(s) to be adapted to become different code with additional features, functionality and content. The SRP Dependent Application is accessible and separate from the SRP Core Application with additional or replaceable variable content and variable code available to be downloaded in the form of SRP packets only to the SRP Dependant Application, only to the CORE application or to both.

Additionally, the SRP Dependent Application module includes separate and additional modules of code and content in the form of using prioritized Trans-Snips that may copy and replace code and content within the SRP Core Application or SRP Dependant Application using enhancements or extractable digital information hidden inside the Trans-Snip such as within the graphics portion of the Trans-Snip. In this manner the activation or extraction of information from a Trans-Snip that is visible within the normal displayable Full Screen image may be the source of additional or replaceable code, through prioritization or user interface. The core code as well has the optional capability to call up further or replaceable code and content. In this way the core code is adaptable to modify any Trans-Snip having variable content and code, to for example overlay the Trans-Snip with another Trans-Snip or pulling a Trans-Snip out from a lower layer with in the display and in either way changing the prioritization of the Trans-Snip in this way priorities for activation of extraction are variable and can be changed by changing for example the positioning of the variable not the core code.

The core code and dependant code are modular in that either one or the other may perform a copy and replace variable code or variable content and thereby altering the functionality of the core code variables (and/or variable core code), without changing the core code itself, but only altering the digital content of Trans-Snips within the display which may result in additional variable code or may result in differing overlaid priority code for a variable Trans-Snip. The variability and modularity of the Trans-Snip is based on the Coordinate File naming System structured by the Architectural Blueprint as described herein. The Trans-Snips as well are in a Small File Format that provides for significant amounts of replaceable, variable code and variable content to be stored in and be accessible within the Resident Server that is self-contained and refreshed in place without a requirement to access a remote server through a wired or wireless internet connection for additional content.

### BEFORE-NOW-AFTER Information Display

The STAR-RAID-POINT Application further requires no scrolling or zooming and is already properly formatted to immediately display image and textual content on any digital device using its universal SRP code and Universal PictoOverlay Navigation Interface that is accessible by all device formats. Access to all options are visible to the user within the Navigation Interface without pull down menus and any visible item may be selected, by touching, picking with a mouse or other device, selecting from a keyboard or numeric phone keypad, or speaking a verbal command. Having all options available and navigable within a display provides for a user to easily review and find content of interest. The selection of any item within the display immediately displays additional content without resizing the display or requiring the user to zoom, or scroll vertically or horizontally to completely and legibly view the additional content. The display further provides within a quadrant layout display, recently viewed content, current content with options to choose from within the current content and future related content that may be of interest for a user to display or that provides commands and sequence steps to complete a game, puzzle or Multi-Dimensional Presentation. This BEFORE-NOW-AFTER structure of displaying all information simplifies navigation and provides for a user to much more easily find content of interest by reviewing both BEFORE content and AFTER that may all be related to the NOW content or understand the required steps to perform within an application. Every layered Composite Image, Trans-Snip, Option, Button or Quadrant within the Navigation Interface is enlargeable and displayable as full screen within the Main Panel for printing and sending as an email or email attachment in an image format. The STAR-RAID-POINT Application may further provide for a user to construct a favorite content screen that may be chosen for display in the Main Panel.

The Universal PictoOverlay Navigation Interface provides a full screen display of a page of the STAR-RAID-POINT Application has a Main Panel displayed at 1024×768 resolution, a Sub Panel S at 344×768 resolution, and four quadrants A, B, C, and D that provide content, features and access to the STAR-RAID-POINT Application. In Quadrant A, referred to herein as a Montage Page displays eight images in Sub-Panels around a central image that is the same as a selected image from the eight images. The Options shown in Quadrant D that are related to the content in Quadrant A, change as a mouse, finger or other indicator device is moved over the eight images. By selecting an image the center image and Quadrant D options freeze so a user may select from the Options to perform a task or command within the STAR-RAID-POINT Application. Additional, features may be provided in Quadrant B and a full screen display of any one Quadrant or more general features may be accessible using the Variable Buttons within the Sub-Panel. Quadrant C may provide for video and audio playback to present a film-like presentation of features within the STAR-RAID-POINT Application. The user makes these selections without scrolling or zooming, but by simply selecting a Variable Button and because all of the STAR-RAID-POINT content is resident on the device any selection immediately changes the display content without any delay to download or resize an image.

The STAR-RAID-POINT Development Application further uses Variable Graphics Code that is associated with each Trans-Snip which provides, unlike hard coding of an application, unlimited flexibility in modifying any code or content within the application with or without changing the “Core Code” of the application. Using embedded or associated enhancements a Trans-Snip provides for the SRP Core Application code to change, replace, add, and extend the characteristics of any Trans-Snip through priority or otherwise and also add, replace, update, change, add to, or extend the Trans-Snip through any other or SRP Dependant Application code and modify the content associated with that Trans-Snip. A Trans-Snip provides additional power and flexibility to alter current core or resident code and functionality, by changing every aspect of viewable content or by completely replacing code associated with the Trans-Snip. Embedding code to the Trans-Snip provides powerful overlay capability with the embedded code hidden within the pictorial element of the Trans-Snip. This structure of Trans-Snip variables has additional capability of priority, variability and functionality applicable in general but particularly specific to Mobile Core Code/Content and Resident Server Code/Content.

In order to replace content, the POINT Technology provides an Encrypted Coordinate File Format structure that identifies variables through coordinate positions within a structured layout within an Architectural Blueprint. Related components that make up a Trans-Snip, Composite Image, or PictoStory may grouped within the Architectural Blueprint. In addition to downloading new or modified content through an SRP Packet from the STAR-RAID-POINT Application any Trans-Snip, Composite Image, or PictoStory or any variable within these features may be immediately replaced with an alternative Trans-Snip, Composite Image, PictoStory or variable. To copy or replace a variable an alternative variable that includes the desired content is selected and automatically renamed by the software application to the appropriate coordinate file name and stored in a temporary file folder within the Architectural Blueprint which immediately replaces the content within the display of the application. In this way the SRP Content within the SRP Dependant Application on the Resident Server has been changed, but the replaced variable has not been deleted from the Resident Server and is available in a separate file folder for display within the current application or in other applications. The SRP Core Application Code remains the same and has not been modified by the change to a file name within the SRP Dependant Application and the change in the content is displayed.

Each variable and feature within the Data Store Resource and SRP Content is developed using the PictoOverlay Technology and all variables are a Trans-Snip, a Trans-Snip with an associated Enhancement, a Trans-Snip with embedded digital information, Trans-Snips that are graphically formatted text or layered Trans-Snips that form Composite Images or PictoStorys within the STAR-RAID-POINT Application. Any new variable content is also a Trans-Snip that may further provide a change in priority of a Trans-Snip or an Enhancement so that the new variable content is immediately displayed, or the new content is displayed and then fades, or changes in color, or audio associated with the variable plays a song or narration about the content. Priority as an attribute of a Trans-Snip defines the accessibility and timing of an enhancement of the variable content within the display without a necessity to change or add code to the SRP Core Application to have the content properly displayed or activated. The Variable Graphics Code for the Enhancements is therefore adaptable to any device to display sound, visual content, animation or other sound and visual effects within the characteristics and specifications of the device.

### STAR-RAID-POINT Application Small File Format

Trans-Snips in small file format that provide variable content and variable code create features in the SRP Dependant Application and may be transferred in a single bulk data packet and be stored on the Resident Server on the digital device using a minimal amount of memory and storage on the device. The SRP Dependant Application and Data Store Resource of the SRP Resident Server forms the Encrypted Coordinate File Format System for the Architectural Blueprint to display and modify any variable code, variable content or feature such as a Trans-Snip, Composite Image, PictoStory or other Multi-Dimensional display within a SRP Dependant Application. The STAR-RAID-POINT Small File Format replaces the need to access content from the internet and/or a conventional external remote server as required by most mobile devices. The STAR-RAID-POINT Application further divides storage of the STAR-RAID-POINT content between internal storage, ROM, RAM and if available SD Card.

The STAR-RAID-POINT content is minimal in file size because all content is Trans-Snips that are formed using a PictoLayer Generator of the STAR-RAID-POINT Application system. The Trans-Snip is constructed from a raw pictorial image that stylizes the image by shaping, cropping, and sizing a portion of the raw image to create a Pictorial Element. The Pictolayer Generator then removes the white background from the shaped, cropped, and sized Pictorial Element and positions the element within a blank transparent page to form a Trans-Snip. The blank transparent provides a Resolution Cell Map that applies position attributes and coordinates to the Trans-Snip within the structural format of the Architectural Blueprint. Each Trans-Snip includes Digital Information in the form of binary or other formats may be associated to or embedded in the graphics portion of the Trans-Snip to provide for the Trans-Snip to be rendered on the digital device and be shaped, sized located, prioritized and enhanced within the SRP Dependant Application. Enhancements may be associated with the Trans-Snip to add text, music, narration, sound effects, video, visual effects, animation, or any other supportive element to dynamically present the Trans-Snip. By embedding digital information with the graphic portion in a Trans-Snip, a Trans-Snip may provide modularity and unique content and effects as well as provide for replacing the Trans-Snip as a Content Variable and thereby changing the display and feature within the SRP Dependant Application but without changing the SRP Core Application Code.

The Digital Information for each Trans-Snip as well may be minimal in size so that by removing the white background and shaping and sizing a Pictorial Element to form a Trans-Snip, the Trans-Snip is of a negligible file size that may be further compressed within the STAR-RAID-POINT bulk data packet. The STAR-RAID-POINT Application may therefore provide millions of Trans-Snips to be downloaded in a single bulk data set from an external server in significantly shorter time than multiple visits for individual content as is currently typical in web-based or remote server applications. The resident server access further results in immediate access to the resident server content on the digital device. This Small File Format and minimal size of each individual Trans-Snip is clearly different from the downloading of for example 1000 data files in large file format from an external remote data server to display a web site or application which would necessarily take much more time than downloading 1000 STAR-RAID-POINT Small File Format data files that load as a single bulk packet of data.

### PictoOverlay Interface Enhanced Trans-Snip Technology

The STAR-RAID-POINT content display is made in the small file format by using PictoOverlay Technology to layer the Trans-Snips that provide the textual content, function and features of the STAR-RAID-POINT Application. Trans-Snips may be layered to form Composite Images, PictoStorys and other variable content to be used within a Multi-Dimensional Presentation. Trans-Snips further make up all visual content within a display such as option buttons, control buttons, text, graphics, and all other aesthetic and functional features such as controls that provide for a user to select content and change images and features within the display. Importantly, Trans-Snips are distinct from components in object oriented programming such as objects, attributes and variables in that while Trans-Snips similar to other component variables may be associated with code such as code for an Enhancement, a Trans-Snip may further consist of Variable Graphics Content and Digital Information that may be in a binary or other format that is embedded within that Variable Graphics Content. Extracting this Digital Information from the Trans-Snip results in the transformation of code and/or content in either the SRP Core Application or the SRP Dependant Application thereby changing the functionality of the Trans-Snip or Core Application and/or the content of the display. The graphics content and format of a Trans-Snip provides for Text to be displayed as Variable Graphics Content images that can be resized to properly display the textual content without a separate command to resize the text.

A Trans-Snip, within the STAR-RAID-POINT display, may also be prioritized to dictate to the SRP Core Application the sequence of when an associated Enhancement should be activated or when embedded Digital Information must be extracted. Prioritization of a Trans-Snip is determined by where the Trans-Snip is layered within the display. An upper level Trans-Snip may be accessible while code associated with or information embedded within is not. Due to the transparency of a Trans-Snip one Trans-Snip is structurally layered on top of other Trans-Snips providing for this important feature. For example, a in playing a PictoGame such as a PictoPuzzle the accessibility of a Trans-Snip determines the next functional step that will be performed by the SRP Core Application creating a randomness based on the User's actions If a User select an upper layer Trans-Snip that is incorrect with respect to the challenge, the Embedded Digital Information of the Trans-Snip may transform the functionality of the Core Code and content of the display to activate an Enhancement to audibly say “You Lose!” The Enhancement activation may further result in the changing the file name of a Trans-Snip at a lower level to prioritize the Trans-Snip and change the display content to visibly display the words, YOU LOSE! For a user the selection and interaction with the feature buttons within the display may prioritized Trans-Snips to extract or activate content or code to change the display to for example find content, perform tasks, play games, shop, or perform other activities available within the STAR-RAID-POINT (SRP) Application. The prioritization provides for certain enhancements associated with certain Trans-Snip to be accessible to the SRP Core Application or the user without recoding of the SRP Core Application Code.

### Multi-Dimensional Features of the STAR-RAID-POINT Application

The PictoOverlay Interface of the STAR-RAID-POINT Application is Multi-Dimensional which refers to the transformation and expansion of content such as a basic one word textual description into a dynamic pictorial representation that reflects a series of conventional dimensions. A first dimension, as an example in this context, may simply be a one word textual description of a story (e.g. XMAS). A second dimension is a pictorial 2D representation of XMAS for example a Christmas tree. A third dimension is a transparent overlaid layer on that 2D picture such layering a PictoLayer of candy canes or presents over the 2D Christmas Tree. This is done by placing a shaped, cropped and sized additional static two-dimensional pictorial element of a candy cane for example within a transparent layer to form a Trans-Snip. This third dimension creates a layered Composite Image formed from a number of layered Trans-Snips. A fourth dimension may be the addition of time, performed within the STAR-RAID-POINT Application by combining a sequence of dynamic layered Composite Images creating a time sequence or time relationship that presents the events, actions and outcomes of the story. Santa's Sleigh may appear in the sky over the Christmas Tree, for example. A fifth dimension is an infinitely variable set of Enhancements that provide action, movement and depth to the story. In STAR-RAID-POINT of fact, Enhancements may be seen as extending the story beyond the four normally used dimensions, and into many-dimensions to create an adventure that intrigues, entices and entertains the Users of the STAR-RAID-POINT Application. In this example Santa's sleigh swoops down and places a gift under the Christmas Tree with a song such as “We wish You a Merry Christmas!” playing in the background. The Multi-Dimensional aspects of the STAR-RAID-POINT application provide for any layer, or multiple layers to be printed in various formats, so that for example a single layer showing only the candy cane may be printed, without any tedious steps of drawing around and cropping the pictorial element to remove the element from other pictorial elements shown within the image content. The layer may simply be selected and only the candy cane is printed. A complete Multi-Dimensional Presentation may also be printed or emailed and be viewed dynamically by a user using the playback features of the STAR-RAID-POINT application.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### Some of the Objects of the Invention

An object of the invention is to provide a “software development and executable application” system that has a core application and dependant applications and further content and wherein the dependant applications may be installed on an external server or as replaceable-modifiable dependant applications or other core application content within resident server on a digital device where content/code can be added to, prioritized, replaced, expanded, contracted to change, and altered to modify the information and/or content to be displayed.

An object of the invention is to provide a “software development and executable application” system using adaptable and adapting code that provides scalable compatibility and functional adaptability across multiple digital devices such as any computer, cellular phone, smart phone, tablet or other digital device.

Another object of the invention is a software development and executable application that provides files in a small file format using PictoOverlay Interface Enhanced Trans-Snip Technology to be downloaded in a scalable, transparent, adaptable resident server format on a digital device.

Another object of the invention is a scalable, compatible landscape orientation full screen display that is clearly viewable without scrolling or zooming on any digital device.

Another object of the invention is a software application that determines the display characteristics of a digital device to conform content to develop a compatible display that is easily viewable on the digital device.

Another object of the invention is a navigable, page driven software application that is adaptable to be compatible with multiple digital devices.

Another object of the invention is a main panel display made up of modular zoom quadrants that when combined provide a navigable PictoOverlay Interface at a resolution compatible to the lead page of a digital device.

Another object of the invention is a main panel display that includes quadrants and a side control panel that when combined provide a navigable PictoOverlay Interface at a high definition resolution compatible to the lead page of a digital device.

Another object of the invention is the conversion of text to a transparent image based format Trans-Snip using the PictoOverlay Generator of the present invention.

Another object of the invention the development of Trans-Snips that consist of Variable Graphics Content and Digital Information embedded within that Variable Graphics Content that may be in a binary or other format, the Digital Information when extracted resulting in the transformation of code and/or content in either the SRP Core Application or SRP Dependant Application thereby changing the functionality of the Trans-Snip or Core Application and/or the content of the display.

Another object of the invention is utilizing Trans-Snip for all visual content within a display such as option buttons, control buttons, text, graphics, and all other aesthetic and functional features such as controls that provide for a user to select content and change images and features within the display.

Another object of the invention is associating an Enhancement with a Trans-Snip, Composite Image, PictoStory or other feature or variable of the application to add text, music, narration, sound effects, video, visual effects, animation, or any other supportive element to dynamically present the Trans-Snip.

Another object of the invention is the prioritization of a Trans-Snip to dictate the timing of the activation of an Enhancement or Extraction of Digital Information within the content of the application.

Another object of the invention is a Text Interface for text in a Font Driven format.

Another object of the invention is the replacement of variable content Trans-Snips within the dependant application within the resident server without modifying the resident core application code.

Another object of the invention is replacing all or a portion of the SRP Dependant Application code and content to add, copy or replace code or content within the display without modifying the core code of the SRP Core Application.

Another object of the invention is to present features of the invention in a dynamic Multi-Dimensional Presentation.

Another object of the invention is the structuring of the dependant application within the resident server with a data store resource that uses an encrypted coordinate file naming system based on a layout defined in an Architectural Blueprint.

Another object of the invention is a before, now and after structure of information within the navigable PictoOverlay Interface display.

Another object of the invention is the printing of a main panel display at 1024 by 768 resolution to a standard letter size 8½″ by 11″ piece of paper.

Another object of the invention is the sending of a main panel display at 1024 by 768 resolution to an email application.

Another object of the invention is the sending of a main panel display at 1024 by 768 resolution in an image format to be an email attachment.

The present invention is further related to a software application system for universal content display across multiple digital devices, comprising application software installed as a core application on a digital device on a computer system, the core application having code and content and the application software further comprising; an architectural blueprint; a plurality of trans-snips within the architectural blueprint, the plurality of trans-snips forming a main panel and at least one side panel, the main panel having quadrants; and wherein the main panel quadrants and side panel are scalable based on the display characteristics of the digital device to form a page driven, full screen display in a landscape orientation on the digital device. The software application system for universal content display across multiple digital devices further comprises that the plurality of trans-snips have variable graphics content and digital information embedded within that variable graphics content. The software application system for universal content display across multiple digital devices further comprising a dependant application stored within at least one of a resident or an external server and having code and content; and wherein extraction of the digital information from at least one trans-snip results in the transformation of code and content in one of at least the trans-snip, the core application and the dependant application thereby changing the functionality of one of at least the trans-snip, the core application, the dependant application and the content of the display.

The software application system for universal content display across multiple digital devices wherein the transformation of code and content results in the replacement of code and content within the dependant application without modification to the core application code. The software application system for universal content display across multiple digital devices further comprising at least one trans-snip as variable content from the dependant application, the variable content either as an addition to the existing page driven, full screen content or a replacement or partial replacement thereof without modification to the core application code. The software application system for universal content display across multiple digital devices wherein the universal content display presents on a single page at least a display of prior accessed content, current accessed content and optional content that has not been accessed in a before-now-after structured information format. The software application system for universal content display across multiple digital devices wherein at least one trans-snip is enhanced and prioritized to be activated prior to other trans-snip within the plurality of trans-snips to dynamically present text, music, narration, sound effects, video, visual effects, animation, or any other supportive element associated with the trans-snip.

The software application system for universal content display across multiple digital devices has text that is formed as a trans-snip in a graphical format. The software application system for universal content display across multiple digital devices wherein all content within the main panel quadrants and side panel is legible and accessible by a user without scrolling or zooming across the display screen of the digital device. The software application system for universal content display across multiple digital devices wherein the digital device is one of at least a cellular phone, smartphone, tablet computer, laptop computer or desktop computer. The software application system for universal content display across multiple digital devices wherein the main panel is printable in landscape orientation in a standard letter size page format.

The software application system for universal content display across multiple digital devices further comprising a blueprint generator to create at least an enhanced multidimensional audio video presentation. The software application system for universal content display across multiple digital devices further comprising a pictooverlay interface to provide for the selection of content to interact with in a video game. The software application system for universal content display across multiple digital devices further comprising a pictopuzzle generator to create at least one of a pictopuzzle, and pictoidentity. The software application system for universal content display across multiple digital devices further comprising a payment and account entity management system wherein purchased points are accessible to perform a financial transaction by completing a pictoidentity.

The present invention is further related to a method for universal content display across multiple digital devices, comprising the steps of installing application software as a core application on the digital device on a computer system, the core application having code and content; forming a plurality of trans-snips; populating an architectural blueprint with the plurality of trans-snips, forming from the plurality of trans-snips a main panel and at least one side panel, the main panel having quadrants; acquiring the display characteristics of a digital device and scaling based on the display characteristics one of at least a quadrant, a main panel; and side panel to form a page driven, full screen display in a landscape orientation on the digital device. The method for universal content display across multiple digital devices, further comprising the steps of forming the plurality of trans-snips with variable graphics content and digital information embedded within that variable graphics content. The method for universal content display across multiple digital devices further comprising the steps of installing a dependant application within a server, the dependant application having code and content; and wherein the extraction of the digital information from at least one trans-snip results in the transformation of code and content in one of at least the trans-snip, the core application and the dependant application thereby changing the functionality of one of at least the trans-snip, the core application, the dependant application and the content of the display. The method for universal content display across multiple digital devices further comprising the step of transforming code and content that results in the replacement of code and content within the dependant application without modification to the core application code. The method for universal content display across multiple digital devices further comprising the step of updating the full screen display with variable content from the resident server without modifying the core code, the variable content either as an addition to the existing page driven full screen content or a replacement or partial replacement thereof.

The method for universal content display across multiple digital devices, further comprising the steps of associating the plurality of trans-snips with at least one enhancement to dynamically present text, music, narration, sound effects, video, visual effects, animation, or any other supportive element associated with the trans-snip; and prioritizing the at least one trans-snip to activate the enhancement prior to the activation of enhancements associated with other trans-snips. The method for universal content display across multiple digital devices, further comprising the step of forming text as a trans-snip in a graphical format having embedded code. The method for universal content display across multiple digital devices, further comprising the step of displaying the page driven full screen display content legibly and accessible to a user without scrolling or zooming across the display screen of the digital device that is one of at least a cellular phone, smartphone, tablet computer, laptop computer or desktop computer.

The present invention is further related to a universally adaptable software application system: comprising application software installed as a core application on a digital device on a computer system, the core application having code and content, the application software further comprising; an architectural blueprint; a plurality of trans-snips within the architectural blueprint, the plurality of trans-snips forming having variable graphics content and digital information embedded within that variable graphics content; and a dependant application stored within at least one of a resident or an external server and having code and content; and wherein extraction of the digital information from at least one trans-snip results in the transformation of code and content in one of at least the trans-snip, the core application and the dependant application thereby changing the functionality of one of at least the trans-snip, the core application, the dependant application and the content of the display.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a diagrammatic representation of components in a first embodiment of the STAR-RAID-POINT Development Software Application and components that may be used in an embodiment of an SRP Application;

FIG. 2 is also a block diagram of components in a first embodiment of the STAR-RAID-POINT Development Software Application and components that may be used in an embodiment of an SRP Application;

FIG. 3 is a block diagram of components to develop PictoLayers in a first embodiment of the STAR-RAID-POINT Development Software Application and components that may be used in an embodiment of an SRP Application;

FIG. 4 is a block diagram of components of the application of a KeyConcepts Query in a first embodiment of the STAR-RAID-POINT Development Software Application and components that may be used in an embodiment of an SRP Application;

FIG. 5 is a diagrammatic representation of components in a first embodiment of a PictoStory in an embodiment of the STAR-RAID-POINT Development Software Application that may be used in an embodiment of an SRP Application;

FIGS. 6A-6D are diagrammatic representations of components in developing a Trans-Snip in a first embodiment of the STAR-RAID-POINT Development Software Application; the Trans-Snips may be used in an embodiment of an SRP Application;

FIG. 7 is a diagrammatic representation of Trans-Snip Page in a first embodiment of the STAR-RAID-POINT Development Software Application the components of which may be used in an embodiment of an SRP Application;

FIG. 8 is a diagrammatic representation of an embodiment of a Composite Image Page in a first embodiment of the STAR-RAID-POINT Development Software Application the components of which may be used in an embodiment of an SRP Application;

FIGS. 9A and 9B are diagrammatic representations of an embodiment of the STAR-RAID-POINT (SRP) Core Application and SRP Dependant Application within the Resident Server on a digital device;

FIG. 10 is a diagrammatic representation of an embodiment of the STAR-RAID-POINT (SRP) Application Access Levels;

FIG. 11 is a diagrammatic representation of an embodiment of the some components of the STAR-RAID-POINT (SRP) Core Application;

FIG. 12 is a diagrammatic representation of an embodiment of the STAR-RAID-POINT (SRP) Application Universal Navigable Picto Overlay Interface;

FIGS. 13A-13D are diagrammatic representations of an embodiment of the STAR-RAID-POINT (SRP) Application Main Panel with Quadrants of the Universal Navigable Picto Overlay Interface;

FIG. 14 is a diagrammatic representation of an embodiment of the STAR-RAID-POINT (SRP) Application Side Control Panel of the Universal Navigable Picto Overlay Interface;

FIGS. 15A-15F are diagrammatic representations of layered Trans-Snips that create the PictoLayers in an embodiment of the STAR-RAID-POINT (SRP) Application;

FIG. 16 is a diagrammatic representation of layered Side Control Panel with the Main Panel in an embodiment of the STAR-RAID-POINT (SRP) Application;

FIGS. 17A-17C are diagrammatic representations of Universal Navigable Picto Overlay Interface in an embodiment of the STAR-RAID-POINT (SRP) Application;

FIG. 18 is a diagrammatic representation of an embodiment of the STAR-RAID-POINT (SRP) Application Universal Navigable Picto Overlay Interface;

FIG. 19 is a diagrammatic representation of an embodiment of the STAR-RAID-POINT (SRP) Application Universal Navigable Picto Overlay Interface;

FIG. 20 is a diagrammatic representation of an embodiment of the STAR-RAID-POINT (SRP) Application Universal Navigable Picto Overlay Interface;

FIG. 21 is a diagrammatic representation of an embodiment of the components of an STAR-RAID-POINT (SRP) PictoGame Application;

FIGS. 22A and 22B are diagrammatic representations of an embodiment of the formation of a PictoPuzzle of an STAR-RAID-POINT (SRP) PictoGame Application;

FIGS. 23A-23I are diagrammatic representations of an embodiment of the formation of a PictoPuzzle of an STAR-RAID-POINT (SRP) PictoGame Application;

FIG. 24 is a diagrammatic representation of an embodiment of a PictoPuzzle of an STAR-RAID-POINT (SRP) PictoGame Application;

FIGS. 25A and 25B are diagrammatic representations of an embodiment of a PictoPuzzle of an STAR-RAID-POINT (SRP) PictoGame Application;

FIGS. 26A and 26B are diagrammatic representations of an embodiment of a PictoPuzzle of an STAR-RAID-POINT (SRP) PictoGame Application;

FIG. 27 is a block diagram of an embodiment of an outline for PictoKids Adventure in an embodiment of a STAR-RAID-POINT (SRP) PictoKids Application;

FIG. 28 is a diagrammatic representation of a first embodiment of selections made by a User from an Image Selector Montage Pages for Scene 1 of the PictoKids Adventure Presentation Adventure in an embodiment of a STAR-RAID-POINT (SRP) PictoKids Application;

FIG. 29 is a diagrammatic representation of a first embodiment of selections made by a User from the Image Selector Montage Pages for Scene 1 of the PictoKids Adventure Presentation Adventure in an embodiment of a STAR-RAID-POINT (SRP) PictoKids Application;

FIG. 30 is a diagrammatic representation of a first embodiment of a Production Presenter in an embodiment of a STAR-RAID-POINT (SRP) PictoKids Application;

FIG. 31 is a diagrammatic representation of an embodiment of the components of an PictoCash Network in an embodiment of a STAR-RAID-POINT (SRP) PictoCash Application.

FIG. 32 is a diagrammatic representation of an embodiment of a component in a PictoIdentity in an embodiment of a STAR-RAID-POINT (SRP) PictoCash Application;

FIG. 33 is a diagrammatic representation of an embodiment of a component in a PictoIdentity in an embodiment of a STAR-RAID-POINT (SRP) PictoCash Application;

FIG. 34 is a diagrammatic representation of an embodiment of a component in a PictoIdentity in an embodiment of a STAR-RAID-POINT (SRP) PictoCash Application;

FIG. 35 is a diagrammatic representation of an embodiment of a component in a PictoIdentity in an embodiment of a STAR-RAID-POINT (SRP) PictoCash Application;

FIG. 36 is a diagrammatic representation of an embodiment of an Identifiable Image for a PictoIdentity in an embodiment of a STAR-RAID-POINT (SRP) PictoCash Application; and

FIG. 37 is a diagrammatic representation of an embodiment of a PictoIdentity in an embodiment of a STAR-RAID-POINT (SRP) PictoCash Application.

### DETAILED DESCRIPTION OF THE INVENTION

Turning now descriptively to the drawings, in which similar reference characters denote similar elements throughout the several views, the figures illustrate the features and controls of the STAR-RAID-POINT Development Software and SRP Applications.

### An Embodiment of the STAR-RAID-POINT Application

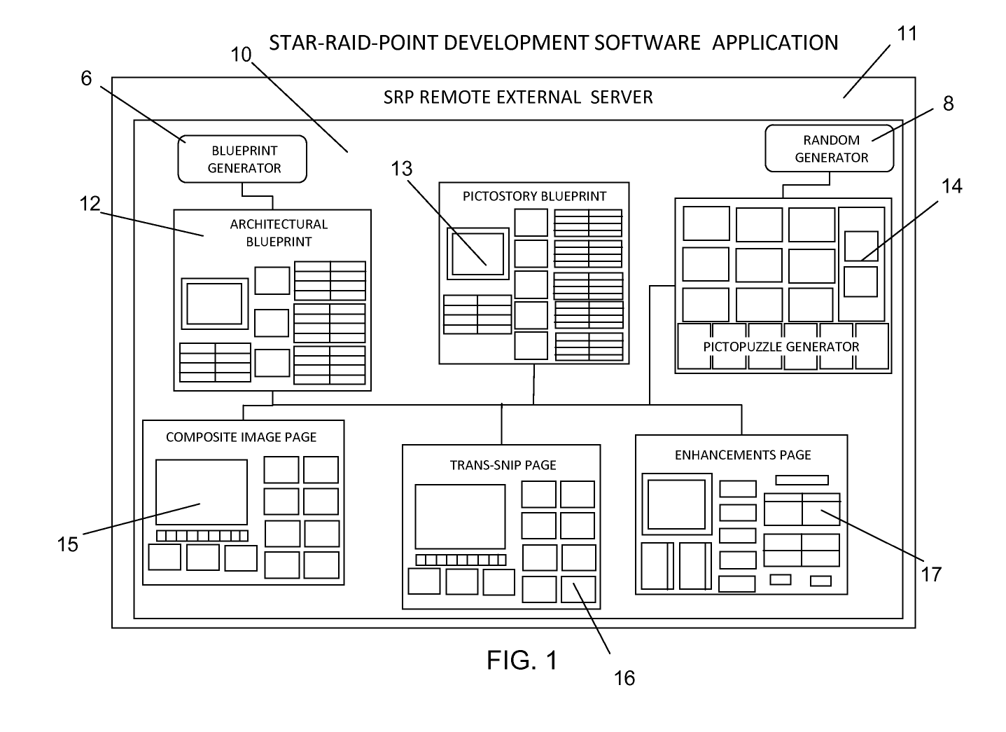

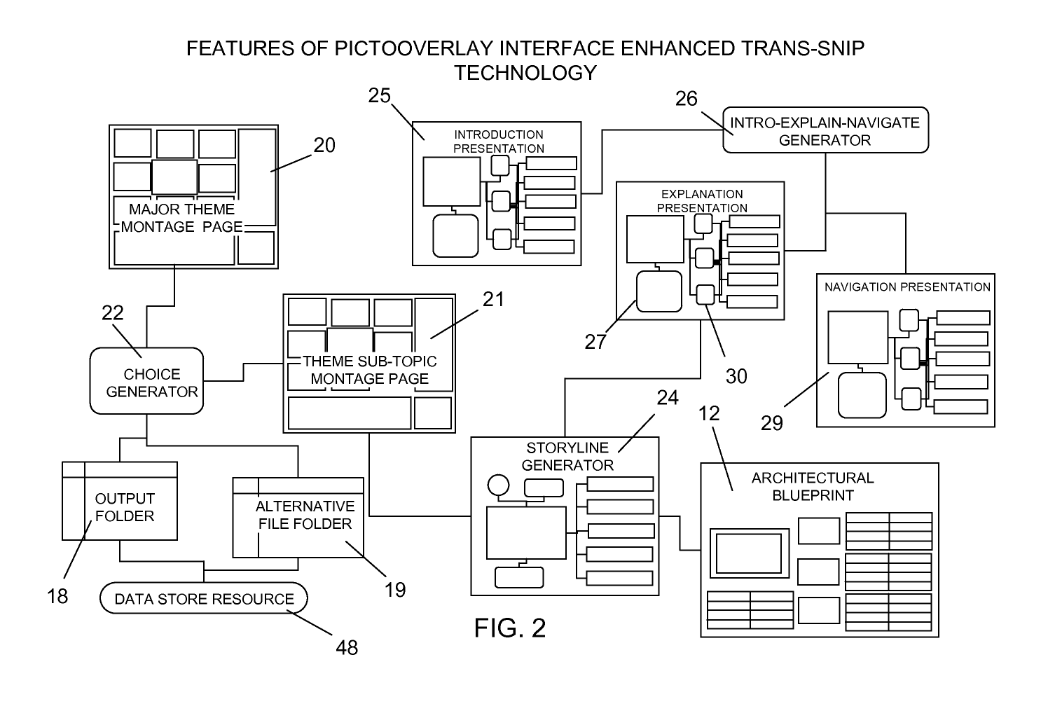

The present invention relates to a software application development system and method for producing, delivering and displaying universally adaptable, scalable content and code that is compatibly displayable in “Core Application” and “Dependant Applications” within a “Resident Server” on all mobile and digital devices including computer, cellular phone, iPhone, smart phone, iPad, tablet computer. The STAR-RAID-POINT Application may be used as a software development platform to create computer and mobile applications, web sites, shopping carts and transactional management systems. The STAR-RAID-POINT Application may also be used to create enhanced featured, displayable, narrated, musicked, Multi-Dimensional Presentations to dynamically present an informative, educational, factual, story, game, puzzle or other artistic creation in an evocative and emotive format. The software application may further be used to develop and maintain a payment and account entity management system to perform secure transactions without entering any personal identification information, login information or passwords. Some components of the STAR-RAID-POINT Application that are used to develop Trans-Snips and other features of the software application are shown in FIG. 1. These components include an Architectural Blueprint 12 that provides the structural format and layout for all other system components. The structure and format for the Architectural Blueprint is determined by the type of computer, internet or mobile application that is being created by the STAR-RAID-POINT Application and is created using the Blueprint Generator 6. Each variable or feature of the software is developed within the Architectural Blueprint 12 using a series of pages to define the file structure and coordinate location of each feature or variable. As shown, a Trans-Snip Page 16 is created for each Trans-Snip, which may then have Enhancements associated with the Trans-Snip that are developed and located within an Enhancements Page 17 within the Architectural Blueprint. A Composite Image may be formed by layering a number of Trans-Snips within a Composite Image Page 15. These Composite Images may be combined to form a PictoStory within a PictoStory Blueprint 13 that is also located within the Architectural Blueprint 12. In other applications, the Trans-Snips may be layered to create games or puzzles using a Random Generator 8 and PictoPuzzle Generator 14 to develop for example a PictoPuzzle that has a series of challenges that must be completed where each challenge may add or take away Trans-Snip within the PictoPuzzle. The STAR-RAID-POINT Development Software Application may be installed on a remote external server 10 with features and components downloaded to the SRP Core Application or Dependant Applications within a Resident Server on a digital device to use and play the STAR-RAID-POINT Applications such as PictoStory, PictoKids, PictoGames and other interactive applications.

The STAR-RAID-POINT Applications may be used to develop a series of Introduction Presentations 25, Explanation Presentations 27 and Navigation Presentations 29 using the Intro-Explain-Navigate Generator 26 to create a set of pictorial presentations that are short and comprehensive to convey the unique features and explain how to use an STAR-RAID-POINT Applications such as how to play PictoKids or complete a PictoPuzzle. The Presentations are constructed from a series of Enhanced Sequenced Instructional PictoStorys 30 that are formed from layered Composite Images 35 derived from information related to the controls and features of a STAR-RAID-POINT Application. The Instructional PictoStorys 30 and their Components and Sub-Components for the Instructional Presentations are placed within the Referenced Page Cell Map of the Architectural Blueprint 12. The Active Components of the Presentations are located and renamed with encrypted coordinate file names associated with positions within a Referenced Page Map and are stored in an Output Folder 18 of the Data Store Resource 48.

As an example, the Introduction Presentation 25 may show a rapid synopsis of using the PictoKids Application Software 10 and the Explanation Presentation 27 may pictorially show a pointer device or mouse selecting controls and demonstrating the functions to create a PictoKids Adventure. The Navigation Presentation 29 may succinctly present navigating through a Theme Choice Montage Page 20 and other features of the STAR-RAID-POINT Application.

### Details of Quadrant A

### Theme Choice Montage Page

An important feature of STAR-RAID-POINT Application is the construction of a series of Theme Montage Pages that include the Major Themes and Theme Sub-Topics for a user to choose from to interact with the software application. In a first embodiment, a Theme Montage Page is in a 3×3 format displaying eight pictures in Sub-Panels surrounding a currently chosen Trans-Snip which may be an image or text representing one of the Themes. The Choice Generator 22 within the STAR-RAID-POINT Development Software Application on the remote server structures a series of Trans-Snips that are related to and encompass a Major Theme. The Major Theme is of a broader scope and may encompass many topics, subjects and lessons that are then broken out into Theme Sub-Topics. For each Major Theme Montage Page 20, a related Theme Sub-Topic Montage Page 21 is developed by the Choice Generator 22. Using the Data Store Resource 48, the Choice Generator 22 groups and stores Trans-Snips related to each Major Theme and Theme Sub-Topic using the appropriate Encrypted Coordinate File Names for their locations within the Montage Page in the Architectural Blueprint. In this way, eight Trans-Snips are associated with a Montage Page and are saved in the active Output Folder 18.

The Choice Generator 22 further groups and stores Alternative Trans-Snips that are related to the Major Themes and Theme Sub-Topics that are also given file names that match the appropriate Encrypted Coordinate File Names for their locations within the Montage Page in the Architectural Blueprint and these Alternative Trans-Snips are stored in an Alternative File Folder 19. This provides for each Major Theme and Theme Sub-Topic to have any number, even millions of Trans-Snip images related to a Theme available to replace a current Trans-Snip in the Output Folder 18 and be presented within the Quadrant A: Montage Page display and because of the Small File Format of the Trans-Snips, the Current and Alternative Trans-Snips are easily downloaded within the SRP Packet to be stored within the Resident Server of the digital device providing for all content presented within the Montage Page to be variable without updating or changing the code of the Resident SRP Core Application. Additionally, an Alternative Folder 19 with new Trans-Snips may be downloaded in the SRP Packet to the SRP Dependant Application to provide completely new content to be available to replace current content without any changes to the code of SRP Core Application. The STAR-RAID-POINT Application content is therefore modular and may be effortlessly changed within any application. The content displayed may be changed through interaction with the software application based on choices by the user or be changed dynamically through Embedded Trans-Snips by extracting Digital Information that results in the transformation of code and content within the SRP Dependant Application or SRP Core Application, or further by the activation of Enhancements or using production control tools to modify a Multi-Dimensional Presentations that is created within the PictoKids, PictoStory or other STAR-RAID-POINT Applications.

### STAR-RAID-POINT Application PictoLayers

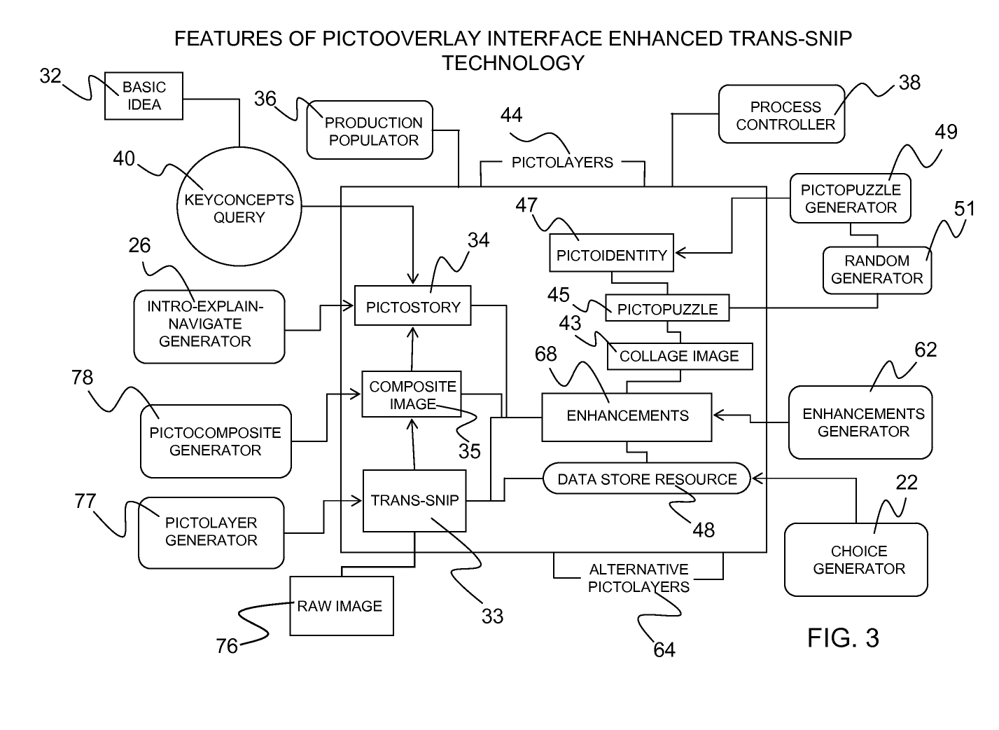

Trans-Snips within a STAR-RAID-POINT Application may be layered and ordered to create Scenes and Part Scenes that transform a user's choices of Major Theme and Theme Sub-Topics into a Multi-Dimensional Presentation using the Storyline Generator 24 within the Architectural Blueprint 12. The Major Themes and Theme Sub-Topics may be structured in such a way to guide a child through a series of choices to create their own unique PictoKids Adventure that is then dynamically enhanced and presented as a Multi-Dimensional Presentations. Each Scene and Part Scene would include a directive for each scene to lead the User to populate the Architectural Blueprint with images that conform to the directive based on an applied KeyConcepts Query 40 used to develop the plot, storyline and structure of the Scenes and Part Scenes of the Presentation. As shown in FIG. 3, a Trans-Snip 33 of a Major Theme or Theme Sub-Topic chosen by a user may be stylized to be used in a Composite Image 35. The Composite Image 35 may be combined with other Composite Images 35 to form a PictoStory 34. Using the Storyline Generator 24, the storyline for the PictoStory 34 may be developed by applying the KeyConcepts Query 40 to the structured Scenes and Part Scenes.

For example, the structure of the storyline may have three Scenes with each Scene made up of five Part Scenes. The Storyline Generator 24 formats the layout of a portion of the Architectural Blueprint 52 to match this storyline structure. Using the Choice Generator, the series of Major Theme and Theme Sub-Topic Montage Pages 49 are developed for each of the Scenes and Part Scenes structured by the Storyline Generator 24. The user may then choose from these series of Montage Pages to select the characters, settings, actions and outcomes for each Scene and Part Scene. The user's choices are then dynamically transformed by applying Enhancements to one or more PictoLayers 44 of the PictoStory 34. A PictoLayer 44 is a Trans-Snip 33, a Composite Image 35, a PictoStory 34 or other layered content, such as Collage Image 43, a PictoPuzzle, or a PictoIdentity 47 or other features that may be constructed using the STAR-RAID-POINT Applications.

KeyConcepts Query: Where? When? Who? How? Why? What Happens? and Wow?

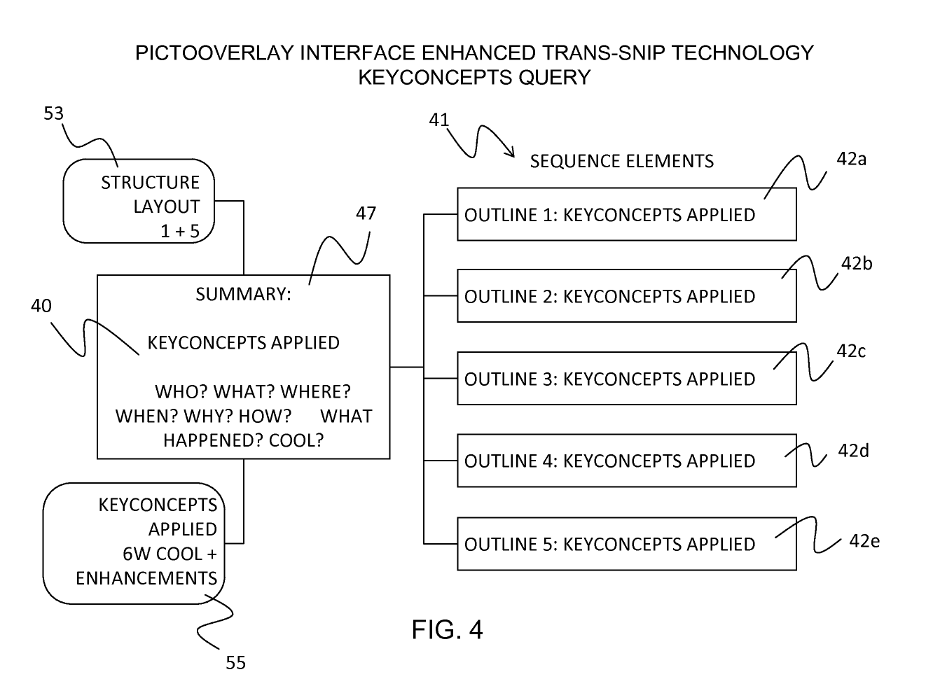

The Storyline Generator 24 includes features to apply the KeyConcepts Query 40 to the chosen Theme. The Theme may be a concept or picture that presents a Basic Idea such as the word XMAS or a picture of a XMAS tree that is then extended and expanded into a Structured Layout 53 that is used to format the PictoStory Blueprint 13. The Structured Layout 53 identifies an appropriate Sequence of Elements 41 that is a pre-determined set number of Elements or that is of any adequate number of Elements to describe the facets and depth of the Basic Idea 32. This Structured Layout 53 determines how many Scenes and Part Scenes will be used in the PictoStory. As shown in FIG. 4, for each Element 41, the KeyConcepts Query 40 is applied that gathers information about the Basic Idea 32 through a set of questions such as the 6W Cool questions “Where?, When?, Who?, How?, Why?, What Happens?” and “Wow?” From the answers to these questions, a Textual Outline indicated as 42a-42e is developed. Based upon the complexity of the Basic Idea 32 of the Major Theme and Theme Sub-Topic, any number of Scenes and Part Scenes with Elements and Outlines 42 may be structured. A Summary Textual Outline 42f may also be developed from the gathered Textual Outlines 42. The Textual Outlines 42 are used in a top-down approach to represent the Basic Idea 32 textually and these are then used to develop a series of Composite Images 35 that are used in the PictoStorys 34 for each Scene and Part Scene structured within the storyline.

### Development of a PictoStory Using the PictoStory Blueprint

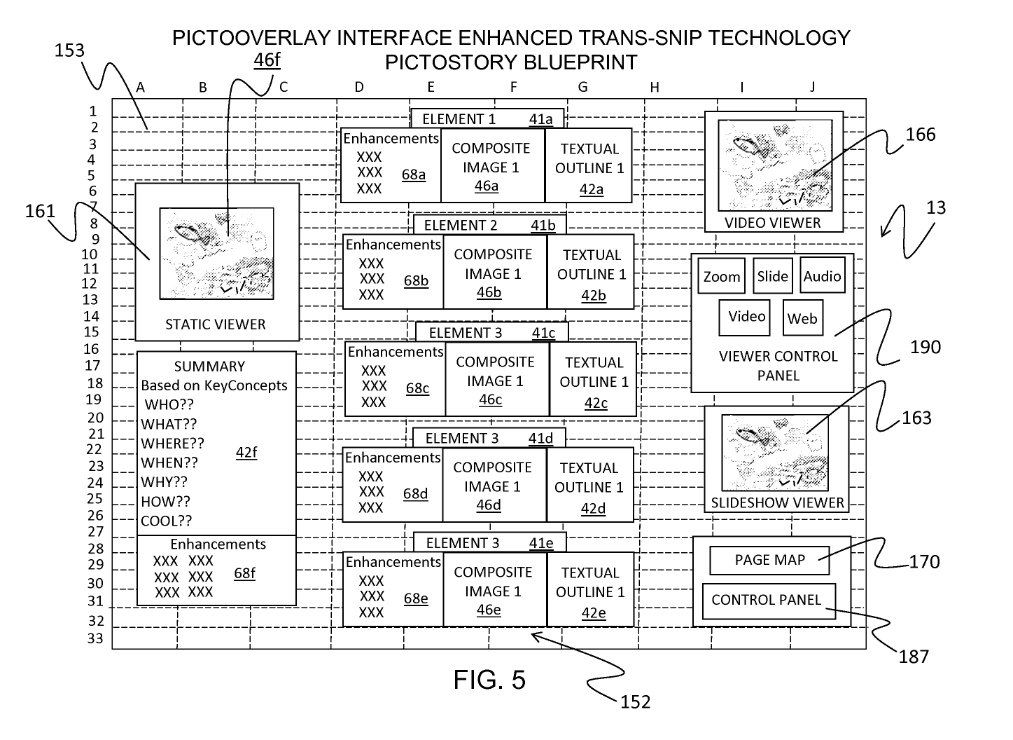

To develop a PictoStory the Architectural Blueprint is formatted to match the number of Textual Outlines and Basic Idea Summary. In a first example as shown in FIG. 5, the Basic Idea 32 is structurally divided into a Series of Five Elements 41a-41e and a Summary 47 and the Architectural Blueprint 12 is formatted with structured page locations for each of these Five Elements 41a-41e and the Summary 47. This Structured Layout 53 is expanded into Page Displays for the Components and Sub-Components that make up the PictoStory 34 and pictorially represent the Basic Idea 32 as a navigable sequenced Page Driven Display of pages in a matrix format within the generated PictoStory Blueprint 13. The Five Textual Outlines 42a-42e for each of the Five Elements 41a-41e and the Summary 47 are located as columnar ‘Page Displays’ within the PictoStory Blueprint. In this top down approach, the Basic Idea 32 has been transformed to an expanded textual description and the PictoStory Blueprint 13 has been initially populated with only this set of textual descriptions of the Basic Idea 32. A bottom up approach is then applied to create a set of pages of pictorial representations of the Five Elements 41a-41e. A first step is to categorize a functional group of Raw Images 76 related to the Basic Idea 32 based upon the responses to the KeyConcepts Query 40 for each of the Five Elements 41a-41e. In this categorization, images relating to the answers to the 6W Cool Questions of Where? When? Who? How? Why? What Happens? and Wow? are grouped within structured file folders using Encrypted Coordinate File Names representing locations within the PictoStory Blueprint 13. A single group of Raw Images 76 representing a KeyConcept Query 40 is displayable in an Image Selector Montage Page, for example for a What response, rows and columns of images of XMAS trees may be displayed to represent the Basic Idea pictorially.

### Trans-Snip Formation

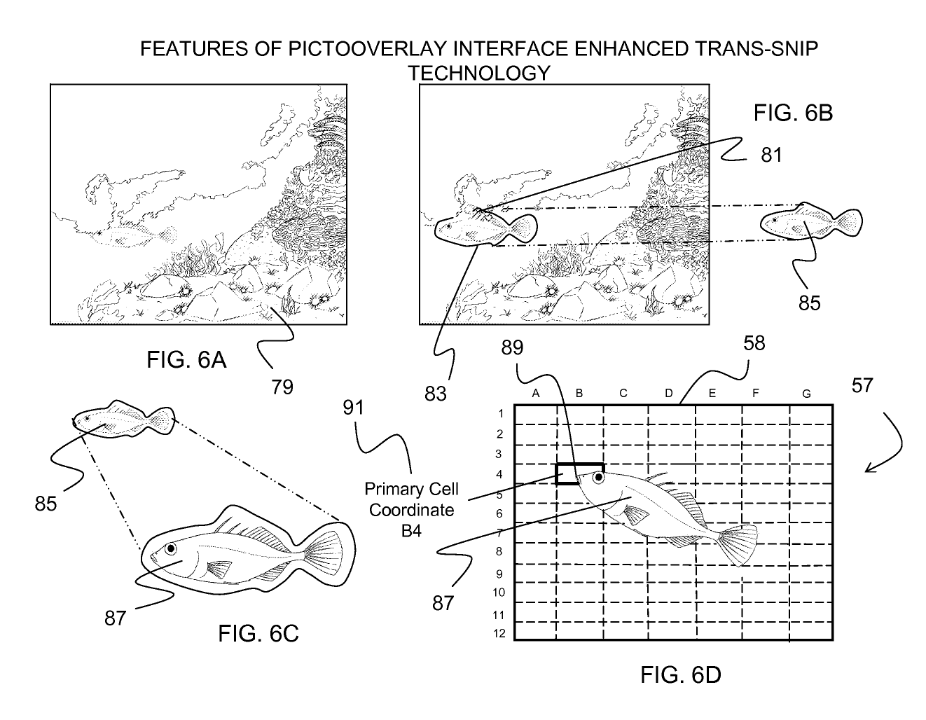

Raw Images 76 from these Montage Pages are then selected, using the PictoLayer Generator 77 and stylized by shaping a portion of the Raw Image using a stencil tool 83, and cropping 81, and sizing 85 a portion of the Raw Image 76 to form a Pictorial Element 87 as shown in FIGS. 6A to 6D. The Raw Image 76 may be shape cropped into any shape by moving the cutting tool 81 over a portion of the Raw Image 76 or by selecting a preset shape such as an oval or rectangle using the PictoLayer Generator 77. In this example, the Raw Image 76 is a fish that is outlined 83 and cut out 85 in the shape of the fish. The shape cropped image 85 is resized 87 to any desired dimension within the horizontal and vertical limits of a Transparent Blank 57. In this example, the fish cut out 87 is enlarged and the white background around the image is removed. A white background is commonly created using a variety of snipping software tools for cropping an image. An exclusive feature of the PictoLayer Generator 77 is the removal of any white border providing for the Trans-Snips 33 to form a layered Composite Image 35. The fish image 87 is located on the Transparent Blank 57 that includes a Referenced Resolution Cell Map 58 to locate the image 87. The image 87 may further be oriented in any direction and be given a cell reference location by aligning for example its furthest left highest point 89 to indicate in this example, the coordinate position of B4 indicated as 91 within the Resolution Cell Map 58.

### Trans-Snip Page

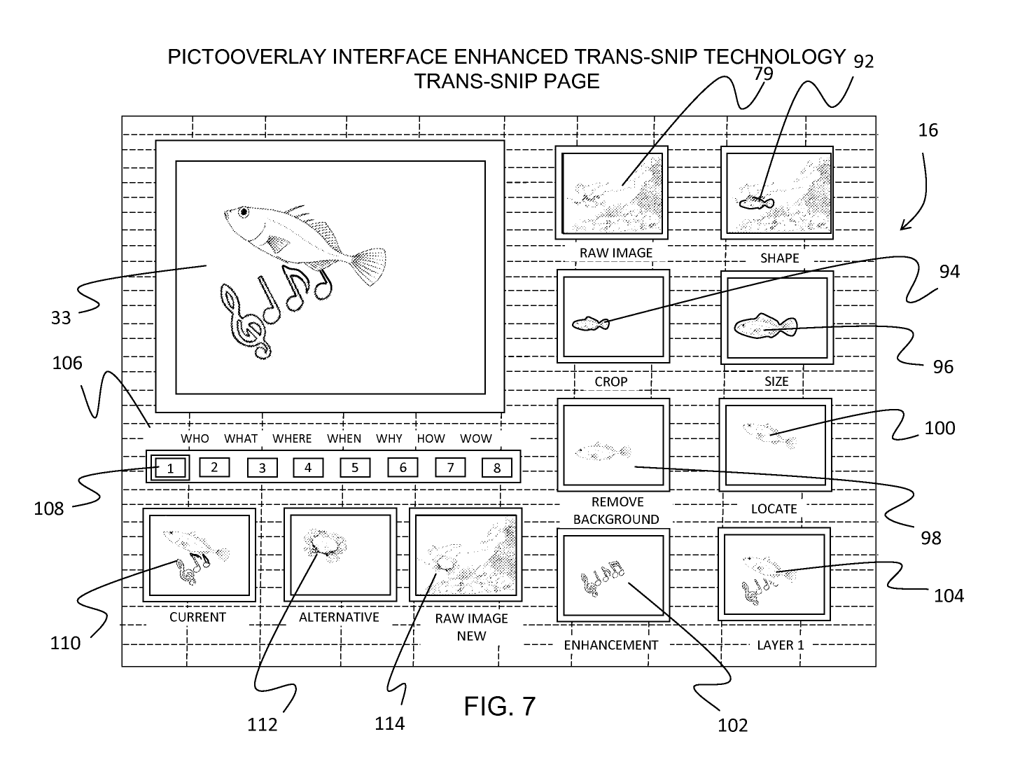

The process and sub-components of a Trans-Snip 87 including the Raw Image 79 is displayed within the Populated Architectural or PictoStory Blueprint 13 on a layered Trans-Snip Page 71 as shown in FIG. 7. Each process step is displayed including the shaping of the image 92, the cropping of the image 94, the sizing of the image 96, the removal of the white background 98, locating the image on the Resolution Cell Map 100, associating the image with one or more Enhancements 102, and forming the Trans-Snip layer 104. Using the Production Controls 27 of the Blueprint Generator 52, the Trans-Snip Page 90 further provides KeyConcepts Indicators 106 and a Navigation Toolbar 108 to select a process step image. Alternatives for each layer are also displayed with the Current Component layer 110, the Alternative Component layer 112, and the Raw Image of the Alternative Component 114. The Trans-Snip may further include Embedded Digital Information within the Variable Graphic Content of the Trans-Snip.

### Formation of a Composite Image

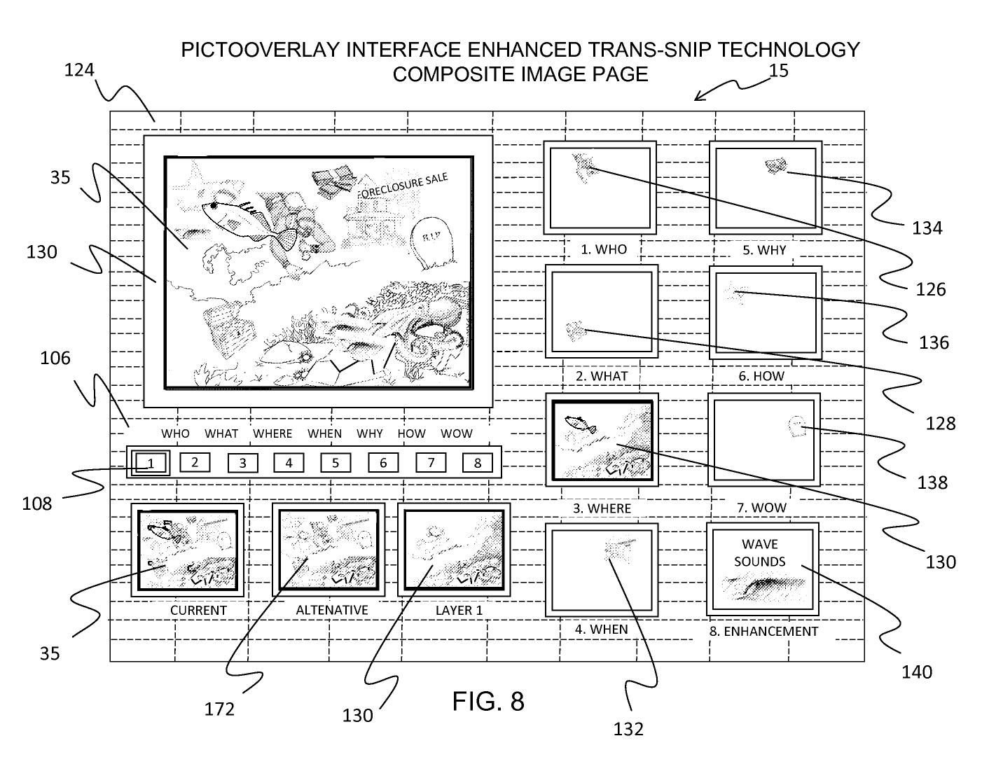

Using the PictoComposite Generator 78, a layered Composite Image 35 is formed by layering a number of Trans-Snips 33. A Composite Image Page 15 is shown in FIG. 8 that includes a layered Composite Image 35 and each of the layered Trans-Snip Components and Sub-Components. In addition to the Resolution Cell Map 57, the Composite Image Page 15 provides a second coordinate system, a Referenced Cell Map 124 to locate, navigate and modify the layered Trans-Snips 33. Each of the Trans-Snips 33 pictorially represents the Textual Outline 42 of one of the Sequence of Elements 41 to create a Composite Image 35. In this example, the Who response is represented with a sea diver 126, What is a treasure chest 128, Where is an underwater background 130, When shows an event of a foreclosure on a home 132, Why shows a bundle of cash 134, How shows a great white shark 136, What Happened or WOW shows a gravestone 138 and the Enhancement 140 has the sound of waves crashing on the beach dynamically displaying the Basic Idea 32. The Composite Image Page 15 provides the KeyConcepts Indicators 106 and the Navigation Toolbar 108 to select and modify a layered Component of the Composite Image 35. The Composite Image Page 15 further provides options for Alternative PictoLayers 172 based on the KeyConcepts 40. To select an Alternative PictoLayer 172 to replace an Interactive Component a current Composite Image 35 with the Alternative PictoLayer 172 and the layer of interest 130 to display the appropriate information for replacement.

The Architectural Blueprint 12 within the STAR-RAID-POINT Development Software Application 10 provides for direct navigation access to any Component or Sub-Component to any Page. Each PictoLayer 44 within a Page has an X, Y and Z Resolution Cell Map Coordinate within each the Trans-Snip 33 and an X, Y and Z coordinate within each Referenced Cell Map 124 of the layered Composite Image 35. This structure further provides for Enhancements 68 to be linked at any Multi-Dimensional level; to any PictoLayer 44, to any Trans-Snip 33, to any Composite Image 35 or to a group of Composite Images within a PictoStory Blueprint 13. The PictoStory Blueprint 13 provides a further coordinate system of a Referenced Page Map 170 to further navigate or modify any PictoLayer 44, Component or Sub-Component.

The Storyline Generator 24 may also create much higher level in-depth PictoStory or PictoFilm Presentations having multiple Acts, Scenes, and Part Scenes using the STAR-RAID-POINT Development Software Application 10 on the remote server and then downloading the Multi-Dimensional Presentation in an SRP Packet to be viewed on a digital device. The Alternative Trans-Snips or PictoLayers 64 and variable content of the STAR-RAID-POINT Application could provide for the presentation to be easily modified providing a user the ability to change setting, characters, actors, actions and outcomes within the storyline of the Multi-Dimensional Presentation.

A number of mobile applications, video games, web site development, and other applications may be developed using the unique structural formatting and Coordinate File Naming System of the Architectural Blueprint and the features and content of the STAR-RAID-POINT Development Software Application 10. Some of these development features may be available only on the Remote SRP Server. Other development features and applications developed using the Architectural Blueprint and the STAR-RAID-POINT Development Software Application 10 are downloaded in the SRP Packet to a digital device.

The STAR-RAID-POINT Development Software Application 10 is available through a network or internet connection on an external SRP Remote Server 11. The SRP Remote Server 11 may be implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a User to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area Network, such as the Internet. Still further, the processor unit 5 may be programmed, as is well known in the art, for storing the software program internally. A printer or other output device can also be connected to the processor unit 5 for printing a hardcopy of the display from the computer system. The processor unit 5 can have a network connection, such as a telephone line, network cable or wireless link, to an external Network, such as a local area network or the internet.

The output device 7 provides visually to the user transactional, interactive or variable data that has been subject to transformations. The output device 7 can be a monitor or other visual computer screen or graphical user interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 can store a computer program or software application product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection. One or more of the devices to access the application software may be connected wirelessly, such as by a cellular link, either directly or via a Network. It is to be appreciated that such devices can be mobile devices (e.g., PDA, iPod, iPad, tablet computer or smartphone that can be used as a processing unit, a display unit, or a unit to give processing instructions), and as a service offered via the World Wide Web.

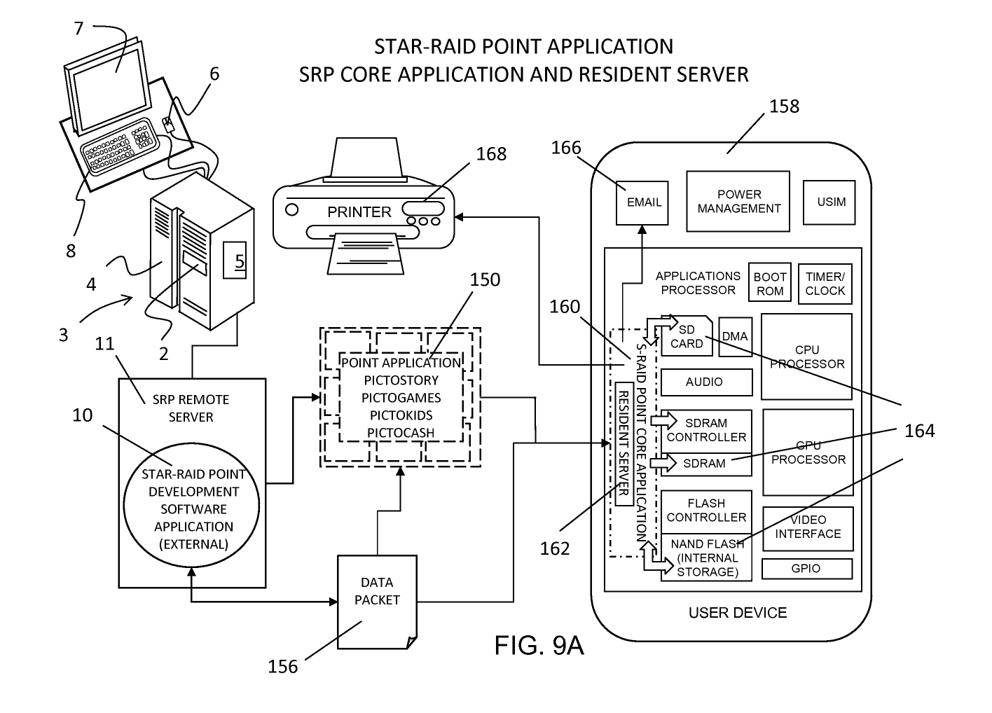

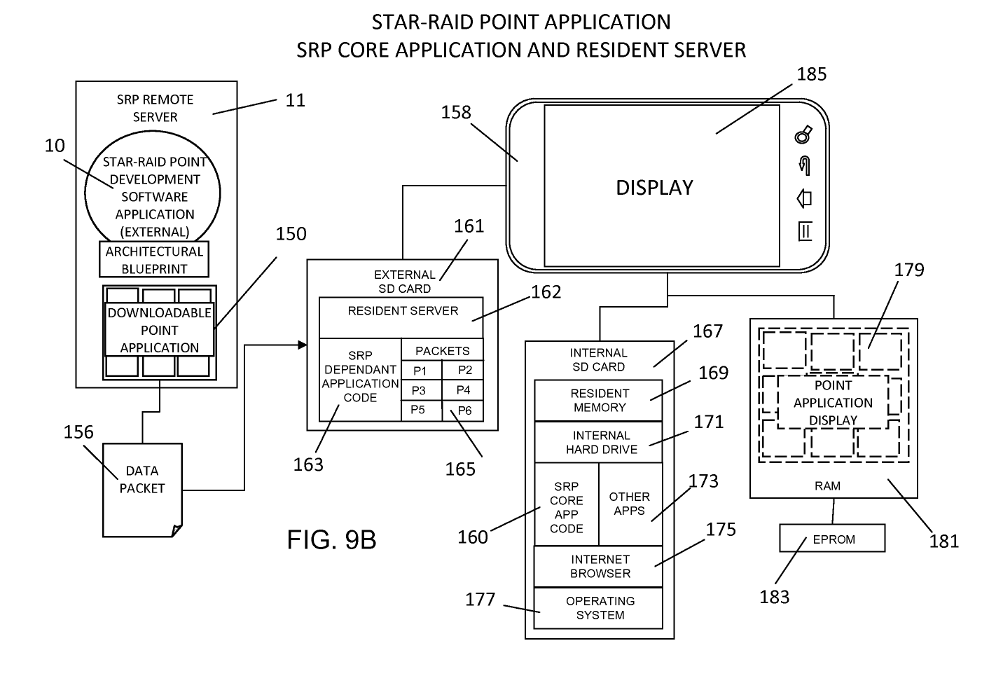

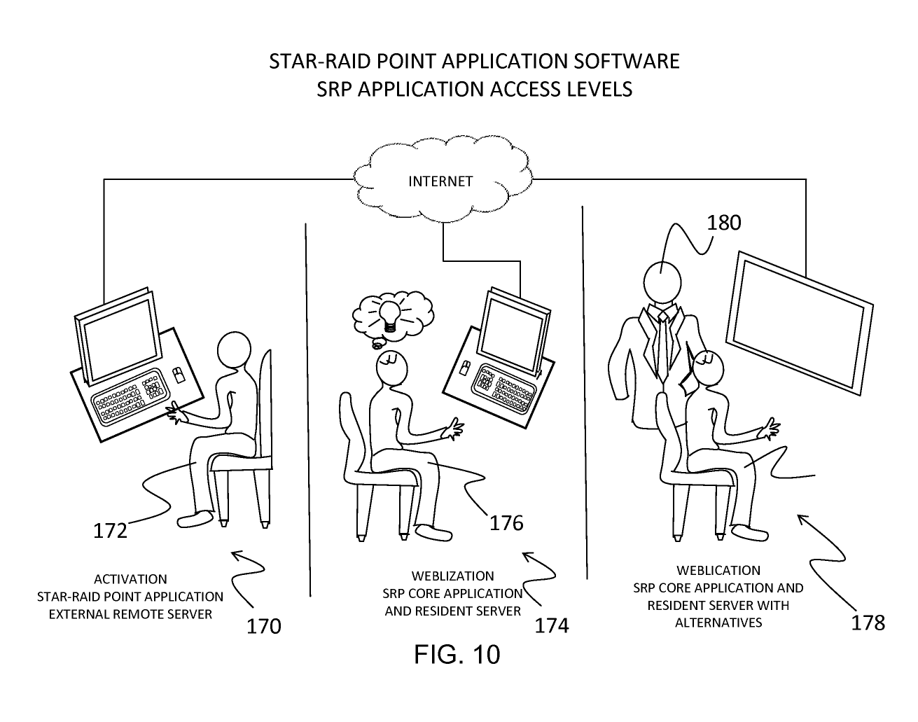

One or more STAR-RAID-POINT Applications 150 may be downloaded in an SRP Packet 156 to a digital device. As shown in FIG. 9A, in installing a STAR-RAID-POINT Application to a smartphone or other digital device 158, the SRP Core Application 160 downloads and configures the SRP Dependant Applications 163 and the Resident Server 162 for the variable SRP Content. The SRP Dependant Applications 163 with the Resident Server 162 is structured with the layout, formatting and Encrypted Coordinate File Naming system as defined in the Architectural Blueprint 12 for the particular STAR-RAID-POINT Application 150 that is being downloaded. For example, a PictoKids Application may include a number of PictoStory Blueprint Pages while a PictoPuzzle may instead have a number of Collage Image Pages, while a PictoCash Application may include a PictoIdentity. However, multiple STAR-RAID-POINT Applications 150 may be installed to the SRP Resident Server 162 with a single SRP Core Application 160 installed on the digital device 158. The SRP Core Application 160 further distributes storage and utilization through available types of system memory and processors 164 to reduce consumption of system resources. As shown in FIG. 9B, the Resident Server 162 may be configured in the External SD Card 161 with the SRP Dependant Application 163 and Downloaded SRP Packets 165. The SRP Core Application 160 is installed on the internal hard drive 171 and Resident Memory 169 of the Internal SD Card 167. The SRP Core Application 160 and other applications 173 may access native code of the digital device 158 through the digital device Operating System 177 and Internet Browser 175. The downloaded SRP Application 150 is stored in RAM 181 and programmable ROM 183 to display 185 on the digital device 158. This combined with the comparatively minimal resources needed to run the SRP Core Application 160 and transfer data locally from the SRP Dependant Applications 163 within the Resident Server 162 to be displayed on the navigable PictoOverlay Interface makes each of the STAR-RAID-POINT Applications 150 well suited as a mobile application that will not leave a user staring at the screen waiting for more information to download and display.

### SRP Application Access Levels

The SRP Core Application is integrated with the native code on the digital device 158 to send and receive through an email server 166 the Main Panel display. Any SRP Application 150 such as a Multi-Dimensional Presentation has viewing levels and compression features that provide for the presentation to be emailed to another digital device 158. The viewing levels are administrative controls that control the access to the Multi-Dimensional Presentation. A first level of access, Activation, is only accessible using the STAR-RAID-POINT Development Software Application 10 on the remote server 11 and provides complete access to view all content and variable content within any SRP Application 150 to control, arrange, change, modify, replace and edit the content of all PictoLayers 44 and their Components, Sub-Components and Enhancements. Control System Tools at this access level provide the ability to amplify all or any portion of the content such as to activate a single enhancement associated with a Composite Image 35 or to activate a portion of the Multi-Dimensional Presentation using any number of enhanced Composite Images 35 or other PictoLayers 44. At the Activation level 170, Rendering and Realization is performed by a Developer 172 who using the STAR-RAID-POINT Development Software Application 10 may create and pictorially present, edit, modify, enhance, navigate, and transform a SRP Application 150 and any of its Components and Sub-Components into an E-Enhanced Multi-Dimensional PictoStory Presentation, a PictoGame such as a PictoPuzzle, an in-depth full length Multi-Dimensional Picto-Film Presentation or various other interactive mobile applications. Upon draft or final completion, the Developer 172 renders any PictoStory Blueprint 13, Composite Image 15, or Enhancement Page 17 to provide restricted access for viewing all or any part of a SRP Application 150. The activation is done within the Architectural Blueprint and may be performed using Hyperlinks, macros, Dynamic HTML, Java Script, and other integrated application.

A second access level is WebliZation 174 which provides internal, client-based access to view all or portions of an E-Enhanced Multi-Dimensional Presentation, play and compete in a PictoGame, PictoPuzzle or other SRP Application 150. The WebliZation Access Level 174 installs the SRP Core Application 160 and SRP Dependant Application 163 within the Resident Server 162 on the digital device and allows a user to interact with a Multi-Dimensional Presentation such as allowing a user to create a PictoKids Adventure Presentation within a structured storyline format; to select Alternative PictoLayers 64, Sub-Components and Enhancements and view these changes within a temporary file structure to determine final data content; to play PictoGames or other mobile applications and compete with other users through a network or internet connection; to setup a PictoCash Account, shop and make purchases using a PictoIdentity with an Entity Management Network; and to perform other actions using other SRP Applications 150. The flexibility and compatibility of the SRP Core Application Software 160 also provides for a user to develop Small File Format web sites that include the Universal Navigable PictoOverlay Interface without scrolling or zooming.

At the WebliZation Access Level 174 the SRP Core Application and SRP Dependant Application 163 within the Resident Server provides for a user to add text or pictorial messages to the beginning and end of an SRP Application such as in a Multi-Dimensional Presentation created within for example the PictoKids Application so that the user may introduce their creation and provide a caring sentiment to a viewer, such as, “Grandpa I hope you enjoy my PictoKids Adventure. Get well soon!” The user may then forward the Multi-Dimensional Presentation to a second digital device and if the second user has WebliZation Access 174 then the second user may interact with and possibly modify the presentation using Alternative PictoLayers 64, or compete in a PictoGame or another mobile application. In sending a presentation through an email, the Multi-Dimensional Presentation or other application is compressed to a Small File Format SRP Packet that may be attached to the email. For a user receiving the email, by clicking on the attachment and completing a PictoIdentity to permit access at the WebliZation Level, the SRP packet is downloaded to the second digital device and the SRP Core Application sets up the Dependant Application within the SRP Resident Server and automatically runs the Multi-Dimensional Presentation. The Small File Format provides for the SRP Application to be rapidly downloaded and accessible. SRP Applications 150 may further be interconnected through a network or internet connection to be played competitively against multiple users. The preset resolution in a standard letter size page format also provides for the Main Panel of any SRP Application 150 to display within the body of an email or be attached to an email prepared by a user. The SRP Core Application 160 further provides for any PictoLayer 44 within the Multi-Dimensional Presentation or other SRP Application 150 to be accessible and appropriately formatted to be printed on a printer 168 that is connected to the digital device. Because the Main Panel is formatted as full screen at the default resolution for the device or at the standard resolution for the device the SRP Application 150 provides for the Main Panel to be printed in a standard letter format at 8½ inches×11 inches.

Other features as well such as the selection of Enhancements 68 for a PictoStory 34, the creation of a PictoIdentity, or funding a PictoCash Account may be accessible at the WebliZation Access Level 174. However importantly, the WebliZation Access Level 174 presents only a subset of the features of the STAR-RAID-POINT Development Software so restrictions on access or making permanent changes to an application, or creating a Trans-Snip 33 or other PictoLayer 44 may not be available. For example, at the WebliZation Access Level 174, in a further embodiment, an Enhanced Multi-Dimensional Picto-Film Presentation may be provided in an Enhanced Dynamic HTML, proprietary, internal client-based format that allows a Producer 176 to view, partially edit, and select Alternative PictoLayers 64 such as for KeyConcepts 40 or Enhancements 68. Final rendering for permanent replacement of Alternative PictoLayers 64 and other interchangeable components may not be provided at the WebliZation level, however viewing of presentations incorporating the Alternative PictoLayers 64 provides for a determination of alternatives that may be communicated to the SRP Developer 172 for final rendering to implement the suggested changes by the Producer 176.

The third level of access is the WebliCation Level 178 that provides web based access through a secure website format to view, note, suggest view potential modifications, test, etc. an E-Enhanced Multi-Dimensional PictoStory Presentation; or a PictoKids Adventure Presentation; or may be accessed to watch competitors play an interactive PictoGame. A link to an SRP Application Website may be provided through an email from the digital device. In one embodiment, the viewer 180 at the WebliCation Level 178 may be allowed to suggest and select Alternative PictoLayers 64 associated with a KeyConcept and request a change to a Multi-Dimensional Presentation providing interaction to the viewer to review dictate the characters, settings, events and outcomes of the Multi-Dimensional Presentation. Permanent modifications to the Multi-Dimensional Presentation at this level are prevented, but the changes selected by a viewer are seamlessly integrated into the Multi-Dimensional Presentation using the Alternative PictoLayers 64 associated with the Multi-Dimensional Presentation and the Encrypted Coordinate File Naming Structure defined in the Architectural Blueprint.

Access through WebliCation 178 allows a third party 180, an investor for example to view the final E-Enhanced Multi-Dimensional Picto-Film Presentation through the secure website to for example help the Producer 176 acquire financial backing for the Basic Idea 32 in order to record, film, or perform the Basic Idea 32 as a song, a musical, a video, a play, a video game, a full length movie, an educational Summary or display the Basic Idea 32 in other presentation formats. The Developer 172 publishes the project through the secure website in a .COM format which in turn renders full functionality to all Enhancements and features of the PictoStory Presentation for viewing or selecting and suggesting Alternative PictoLayers 64. With minimal initial investment using the STAR-RAID-POINT Development Software 10 a dynamic E-Enhanced Multi-Dimensional PictoStory or Picto-Film Presentation is created to intrigue, entertain, educate, and have users interact with the Basic Idea 12.

In further embodiments, the WebliCation Access Level 178 may provide for viewers to be the judge of an SRP Application 150 competition, or rank a Multi-Dimensional Presentation, or provide for educators to grade a project developed using an SRP Application. The WebliCation Access Level 178 may further provide for a user to browse, shop and find the information they are looking for on an SRP developed web-site without waiting for additional information to be downloaded and displayed as the user scrolls through a web page on a mobile device. The unique BEFORE-NOW-AFTER structure of information prevents a user from having to go back and forth from one web page to another to compare information presented. The SRP Application access levels provide different levels of users a range of control tools to interact with, modify and expand E-Enhanced Multi-Dimensional Presentation and play, view or compete in a PictoGame or other SRP Application 150 providing a platform to use the application software in a variety of applications.

### SRP Application Universal Navigable PictoOverlay Interface

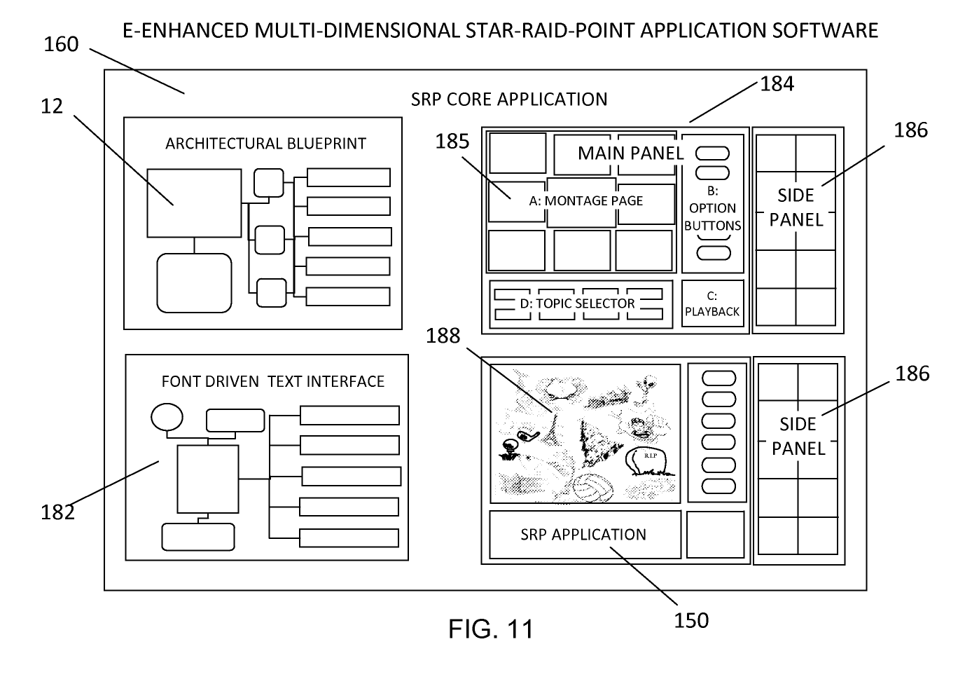

As shown in FIG. 11, the SRP Core Application 160 may include in addition to the Dependant Application within the Resident Server 162 with the Output File Folder Content 18 and the Alternative File Folder Variable Content 19 the structural layout of one or more SRP Applications 150 within the Architectural Blueprint 12, a Font Driven Text Interface 182 for importing text that is not in a graphics format, the Universal Navigable PictoOverlay Interface 184 with a Main Panel 185 and Side Control Panel 186, and the specific SRP Application 150 that is accessed from the Dependant Application within the Resident Server 162, that in an embodiment as shown may be a PictoPuzzle 188.

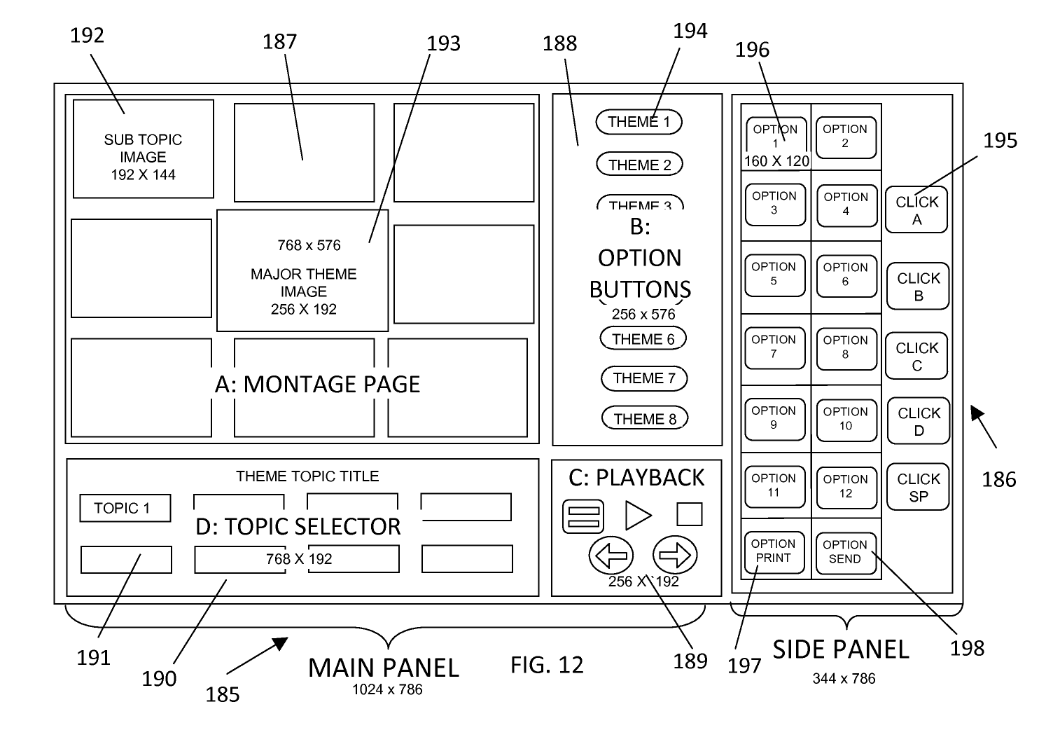

The Universal Navigable PictoOverlay Interface 184 is compatible with all mobile, laptops, tablet computers and other digital device screens because each PictoLayer 44 made up of Trans-Snips 33 within the display is formatted in a preset adaptable layout that is scalable to the standard aspect ratio 4:3 or the high definition aspect ratio of 16:9 and to the resolution characteristics of the lead page on any digital device. In order to display on both a low resolution format, cellular phone, a device with a standard web based resolution, or a high definition display device, the Interface 184 is divided into the Main Panel 185 and Side Panel 186 with the Main Panel 185 being sectioned into modular Quadrants that when combined fit on any digital device as a Landscape oriented, Page Driven, Full Screen display. As shown in FIG. 12, the Main Panel 185 has a preset default resolution setting of 1024×768, the current web standard, and the Side Control Panel 186 has a resolution of 344×768 and the two panels when combined have a High Definition Resolution of 1368×768. The PictoOverlay Interface 184 may therefore be displayed as Full Screen on a High Definition monitor. The PictoOverlay Interface 184 may also be displayed Full Screen on a standard Resolution Monitor at 1024×768 by removing the Side Control Panel 186 from the display and only displaying the Main Panel 185.

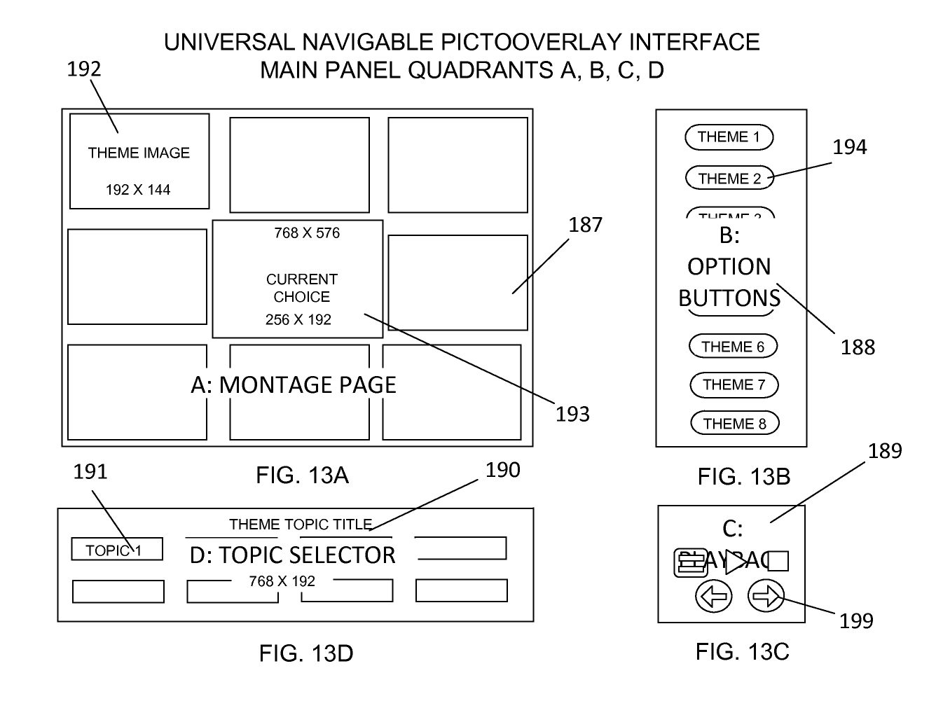

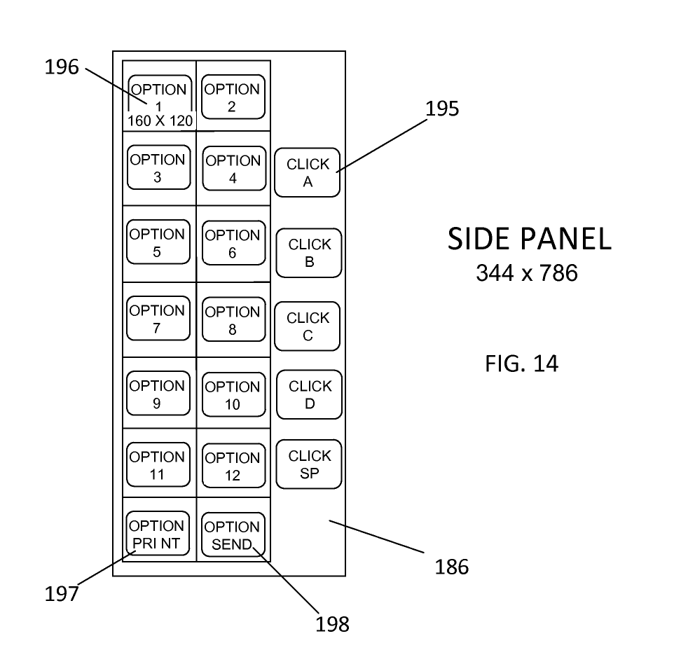

As shown in FIGS. 13A-13D, the Quadrants that make up the PictoOverlay Interface 184 are each sized so that when all of the Quadrants are aligned together the display is at the preset web standard resolution and default aspect ratio or at the resolution and aspect ratio of the “Lead Page” of the digital device 158. At the default web standard resolution, Quadrant A 187 is at a resolution of 768×576, Quadrant B 188 is at a resolution of 256×576, Quadrant C 189 is at a resolution of 256×192, and Quadrant D 190 is at a resolution of 768×192. However, each Quadrant as a composite overlay element made up of Trans-Snips is modular and scalable to the resolution and aspect ratio of the default device 158. In this way images are never distorted or cut off and because there is no scrolling or zooming within the display, the display is always shown as Full Screen. Quadrant A 187 is the Montage Page that display image Trans-Snips in the 3×3 format with eight surrounding theme images 192 and the current image display 193 in a larger format in the center. Quadrant B 188 provides image option buttons 194 that change the content in the Montage Page of Quadrant A 187. Quadrant C 188 provides playback and recording controls 199 and Quadrant D 189 may provide Interactive Controls 191 to use the SRP Application 150.

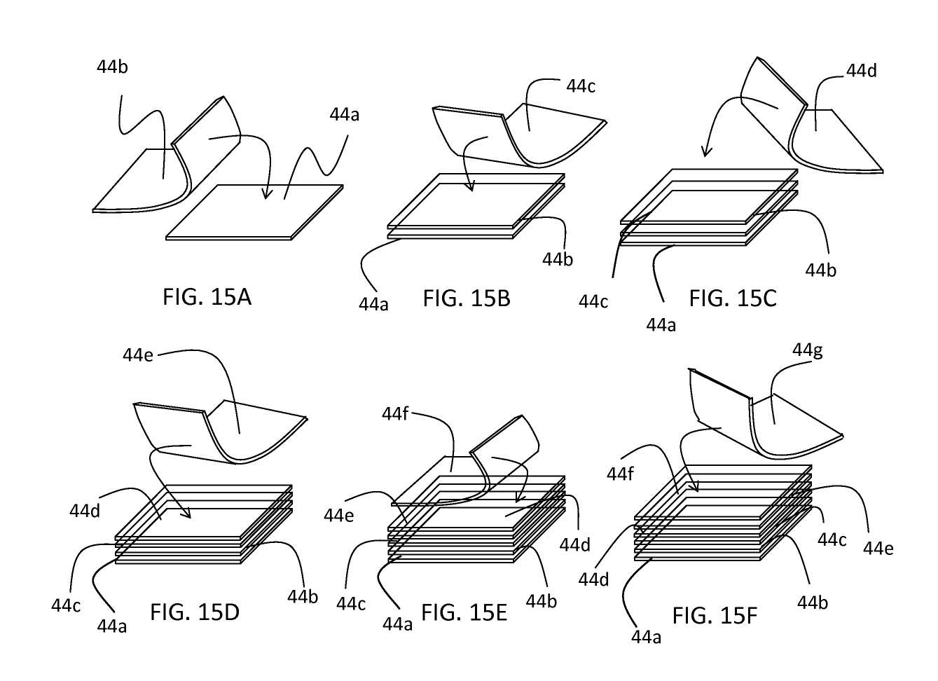

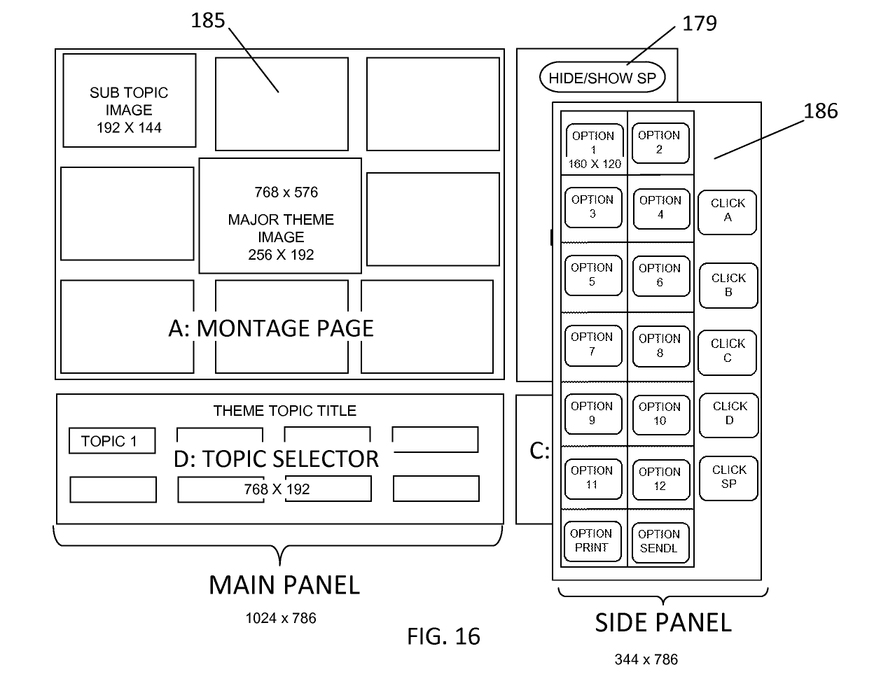

The Side Panel 186 may have any number of controls as needed for the SRP Core Application 160 features such as printing 197 and emailing 198, displaying any Quadrant as Full Screen within the Main Panel using the Quadrant Control Buttons 195 or any other Option Control Button 196 as needed for a particular SRP Application 150. Because every Image, Theme Image, Control Button, Quadrant, Panel and any other component is made up of PictoLayers 44 that are made by layering Enhanced Trans-Snips 33 as shown in FIG. 15A to FIG. 15F, the Side Panel 186 may be displayed as shown in FIG. 16 over the Main Panel 185 using a hide/show option button 179 available in one of the Quadrants.

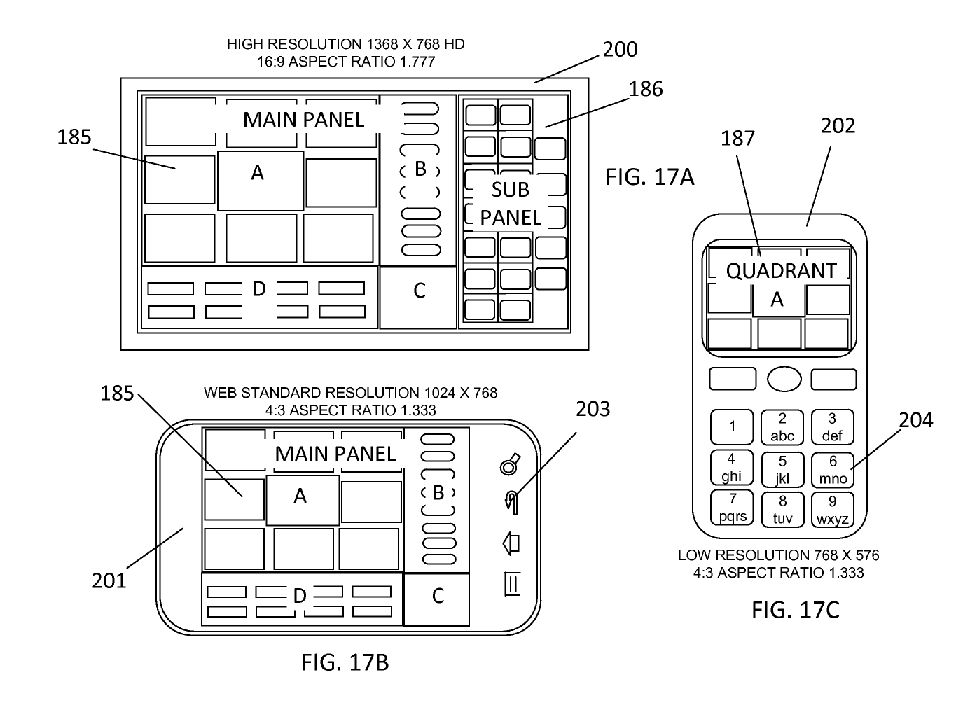

The modularity and scalability of the Quadrants and Panels of the SRP Application 150 makes the display compatible to any device without writing any software code specific to the digital device 158. As shown in FIG. 17A if the digital device 158 has a high definition resolution setting of 1368×768 at 1.777 (16:9) aspect ratio the Main Panel 185 and Side Control Panel 186 are shown in Landscape orientation and Full Screen on the device display screen. As shown in FIG. 17B, if the digital device 158 has a “Lead Page” with display characteristics at the web standard resolution settings then only the Main Panel 185 is displayed at 1024×768 resolution with a 1.333 (4:3) aspect ratio in Landscape orientation and Full Screen. As shown in FIG. 17C, if the digital device 158 has a “Lead Page” with display characteristics at the lower resolution settings then only a Quadrant such as Quadrant A 187 from the Main Panel 185 is displayed at 768×576 resolution with a 1.333 (4:3) aspect ratio in Landscape Orientation and Full Screen. The SRP application 150 further provides for any PictoLayer 44 which includes all components within the display with the exception of Font Driven Text to be modular and scalable to be presented in Landscape Orientation, Full Screen, be printable on a standard 8½″×11 letter size paper, and be sent to the email server 166 on the digital device 158.

### Examples of Optional Blueprint Variability of Standard Selection Interface

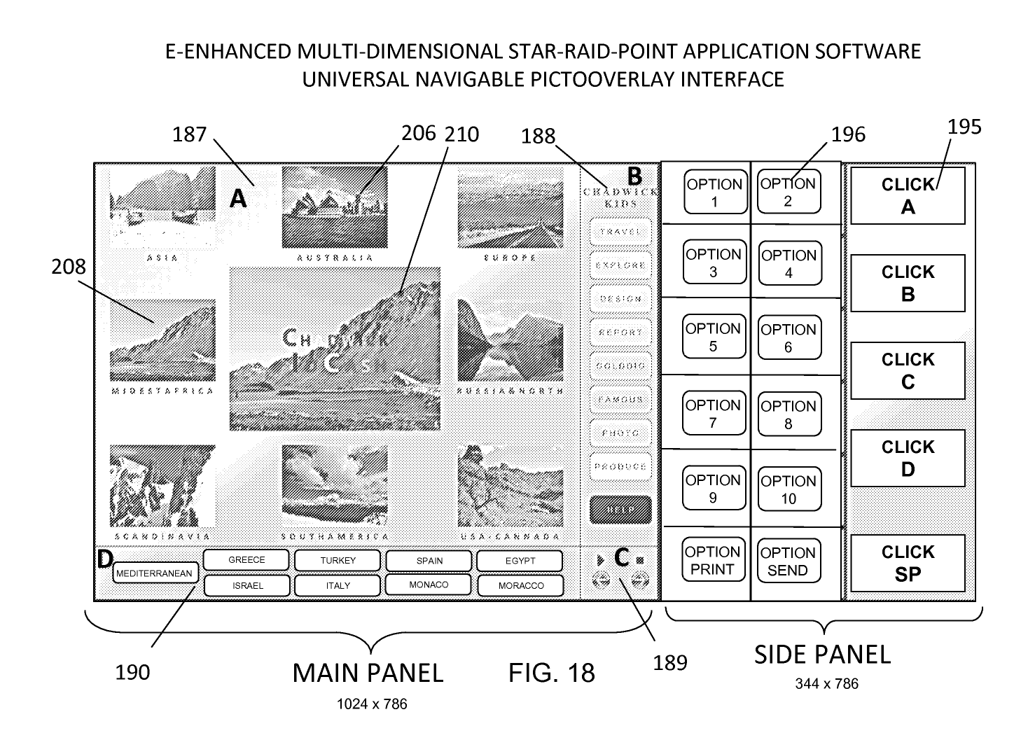

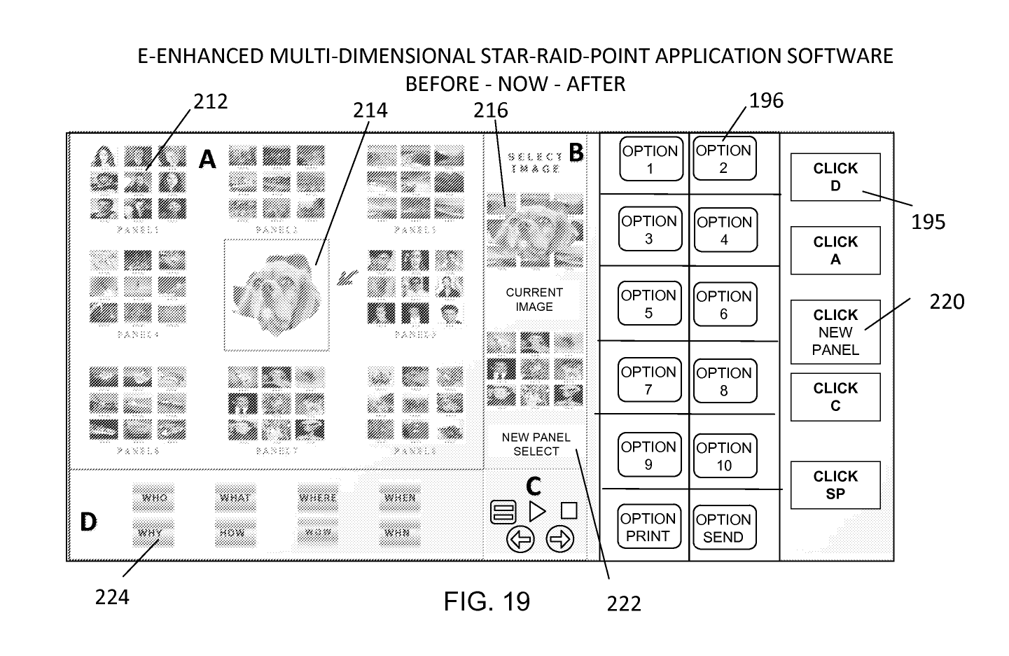

Other unique features within the Universal Navigable PictoOverlay Interface 184 as shown in FIG. 18 are the layout of all controls and images so there is no necessity to scroll or zoom. The selection of any image, option, or control button immediately changes the display, for example selecting one of the eight images 208 displays the image enlarged 210 in the center of the Montage Page. As shown in FIG. 19, the scalability of every PictoLayer 44 also provides for a Montage Page to be scaled to fit as one of each of the eight images 212. In further embodiments, the Interface 184 may provide for navigation through BEFORE, NOW and AFTER content, where the eight images provide previously viewed content, the center image is current content and by selecting in Quadrant B a new Panel 222 with new content may be chosen to change the display. The BEFORE, NOW and AFTER content navigation makes reviewing content for example to shop on a web site much easier to help a user not to search by scrolling, zooming or moving from one web page to another, but instead find and comparing content within a single display.

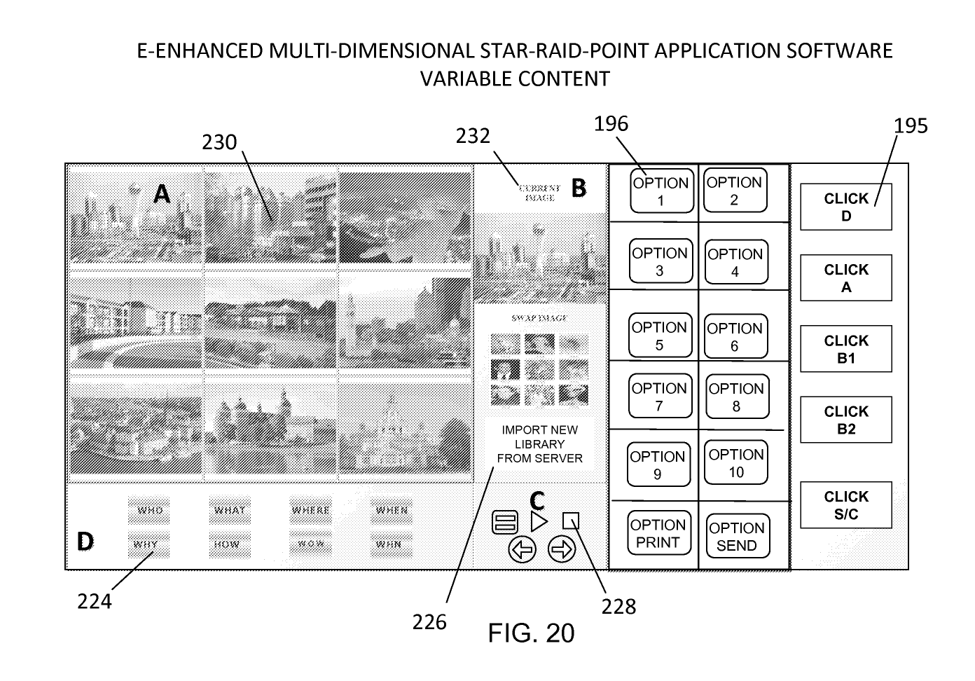

This display may be content included in a SRP PictoStory Application with features related to creating a Multi-Dimensional Presentation related to Chadwick the dog. As shown in Quadrant D 190 KeyConcepts Query may be applied using 6W Cool option buttons 224 to make choices related to the questions of Who? What? Where? When? Why? How? And What Happens? to Chadwick in the PictoStory. The eight Image Sub-Panels surrounding the Central Image may provide images for a user to choose for these answers. For example, as shown in FIG. 20, by selecting the Where Option Images showing places around the world may be instantly displayed for a user to choose from. If an image from the eight images is not acceptable, the user simply selects the Import new library from a Variable Content Button 226 in Quadrant B and instantly a series of eight new images is displayed.

Importantly, because the PictoLayers 44 are formed from layered Trans-Snips, a command or selection may simply be seen as removing a Trans-Snip from an upper layer and displaying the Trans-Snip below thereby keeping the complete full screen visible for the user. For example, if a user selects an option from Quadrant D, all or any portion of the content within may change, and using available options in the Side Control Panel 186, any PictoLayer 44 may be sized Full Screen within the Main Panel 185 for printing or emailing.

### Details of the Enhanced Multi-Dimensional SRP PictoGame Application

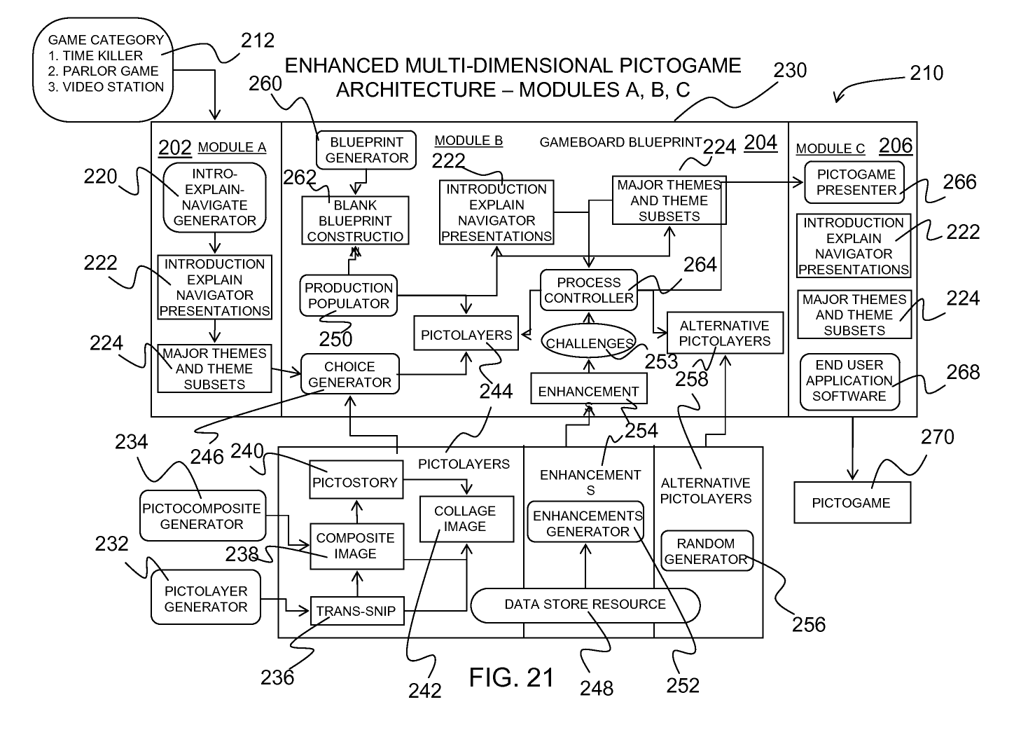

As shown in FIG. 21, in an embodiment of the SRP Application that may be developed using the STAR-RAID-POINT Development Software 10 and played using SRP Core Application and as an SRP Dependant Application within the Resident Server, is the Enhanced Multi-Dimensional PictoGame Software Application 215 may be presented in a number of media formats 212 that are referred to herein as a Time Killer format for mobile device, a Parlor Game format for tablet computers and other electronic devices and in a video station game format for use on interactive video game platforms such as Wii, X-Box, and Play Station among other. The Enhanced Multi-Dimensional PictoGame Software Application 215 is comprised of three Modules, A, B and C that design, populate, and present the PictoGame. In Module A indicated as 202, an Intro-Explain-Navigate Generator 220 creates a series of Presentations 222 to inform and instruct the End User on the PictoGame features, how to play, and how to access the controls of the PictoGame by displaying an Introduction, an Explanation and a Navigation Presentation. A series of Major Themes and Theme Subsets 224 provide the themes and context for the topics, subjects and lessons of thousands of PictoGames that may be accessed through the Major Themes and Theme Subsets Montage Pages.

The Introduction, Explanation and Navigation Presentations 222 and the Major Themes and Theme Subsets 224 are used to develop the format and structure of a Blank Architectural Blueprint 262 using the Blueprint Generator 260. The Major Themes and Theme Subsets 224 are also used by the Choice Generator 246 to scan and select Trans-Snips 236, Composite Image 238 and PictoStorys 240 that are related to the Major Themes and Theme Subsets 224. These PictoLayers 244 have been created using the PictoLayer Generator 232 and the Composite Image Generator 234. The PictoLayers 244 are used to create Collage Images 242 that are formed by layering multiple PictoLayers 244. The Choice Generator 246 uses an encrypted renaming format and stores the selected PictoLayers 244 into a Variable Output Folder (not shown) in the Data Store Resource 248 for use within the PictoGame.

Using the Production Populator 250, the Introduction, Explanation and Navigation Presentations 222 and the Major Themes and Theme Subsets 224 are first selected to populate the GameBoard Blueprint 230. The PictoLayers 244 stored within the Variable Output Folder are then selected and used to populate the Architectural Blueprint forming a GameBoard Blueprint 230 that creates a workspace for the construction and modification of the PictoGame. The PictoLayers 244 are further associated with Enhancements 254 using the Enhancements Generator 252 and Process Controller 264 of the PictoGame Production Tools 227 to create dynamic features and the Challenges 257 that must be completed to win the PictoGame. The SRP PictoGame Application uses a Random Generator 256 that selects Alternative PictoLayers 258 to replace PictoLayers 244 within for example the PictoPuzzle PictoGame. Any style of PictoLayer 244 may have alternatives for replacement, for example any Trans-Snip 236, Composite Image 238 or PictoStory 240 may be replaced with an Alternative PictoLayer 258 of a similar type using the Random Generator 256.

The PictoGame is constructed and is then presented using the PictoGame Presenter 266. The Introduction, Explanation and Navigation Presentations 222 are first presented to the End User to provide an overview, instruction and navigation for using the PictoGame in a comprehensive, succinct, dynamic pictorial presentation to engage the End User and inform them of all of the PictoGame features. The Major Themes and Theme Subsets 224 are then presented for the End User to select the Topics, Subject and Lessons for the PictoGame. The End User Application Software 268 presents the Collage Images and controls for the End User to play and compete in the PictoGame.

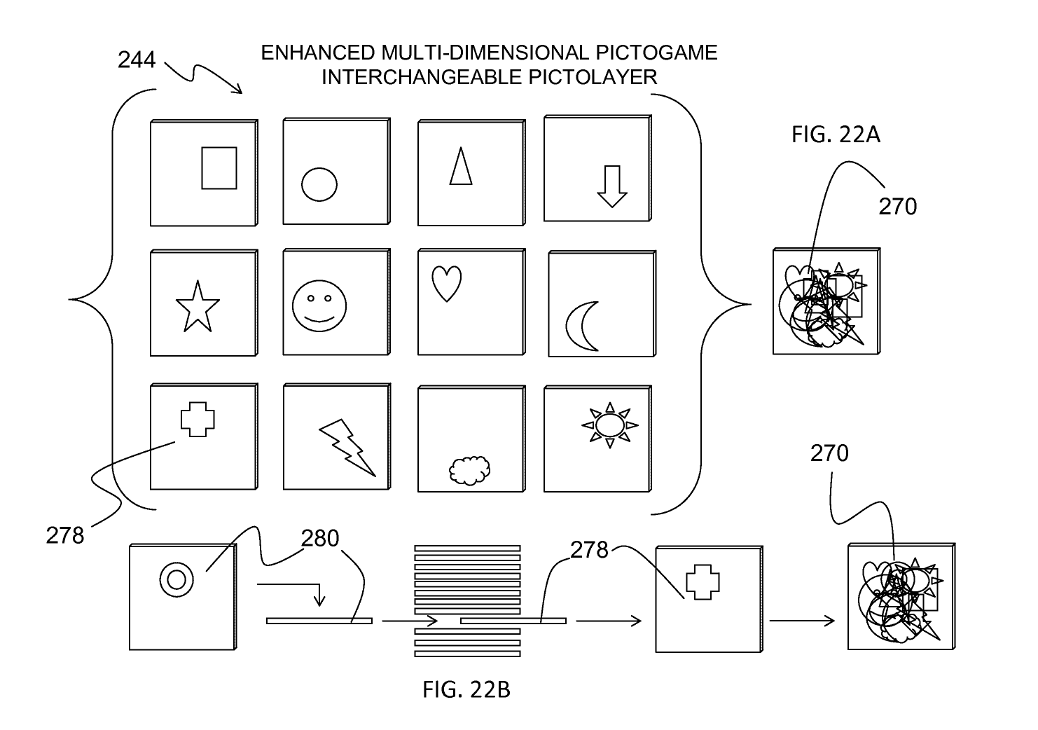

As shown diagrammatically in FIGS. 22A and 22B, the Collage Image 242, is made up of a series of PictoLayers 244 that may include PictoStorys 240, Composite Images 238, Trans-Snips 236, and Enhancements 254 that form the PictoPuzzle 270 and series of Challenges 257. While any PictoLayer 244 is replaceable, the selected PictoLayer 244 may be referred to herein as the Interchangeable PictoLayer 278 and may be automatically replaced with the Alternative PictoLayer 280 by randomly selecting from Alternative PictoLayers 258 that have been categorized and Indexed within the Variable Output Folder by the Choice Generator 246 based on the Major Themes 274 and Theme Subsets 276. A correct response or incorrect response to a Challenge 257 may cause the random selection of the Alternative PictoLayer 280 or a transition to a new Enhancement 254 that presents a new Challenge 257 and changes the Collage Image 242 to a new Collage Image 282 as shown.

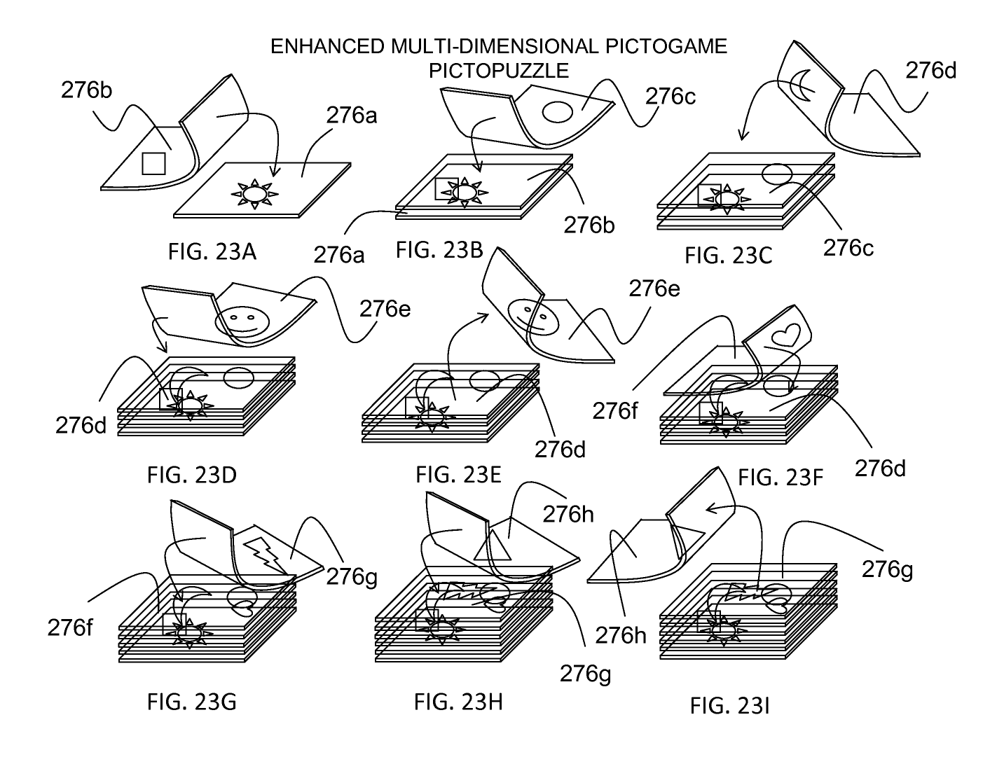

As shown in FIGS. 23A-23I, as challenges are completed both adding and/or removing of PictoLayers is performed. FIGS. 23A-23D show the addition of PictoLayers 276A-276E as Challenges are presented and completed. FIG. 23E shows the removal of PictoLayer 276E which may be because a Challenge 257 was incorrectly completed or an opponent targeted and annihilated the layer, or for other consequences with respect to the Challenge 257. FIGS. 23F-23H show the addition of a subsequent PictoLayers 276f, 276g and 276h and then the removal of 276h demonstrating that as a PictoGame progresses a varied presentation of PictoLayers may be shown to continually visually change the PictoPuzzle 270 creating interesting and engaging Multi-Dimensional PictoGame Presentations.

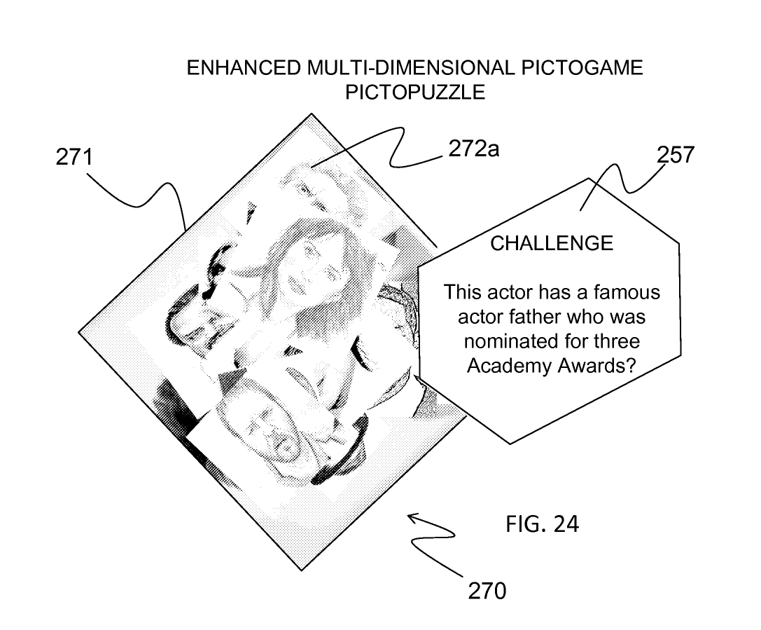

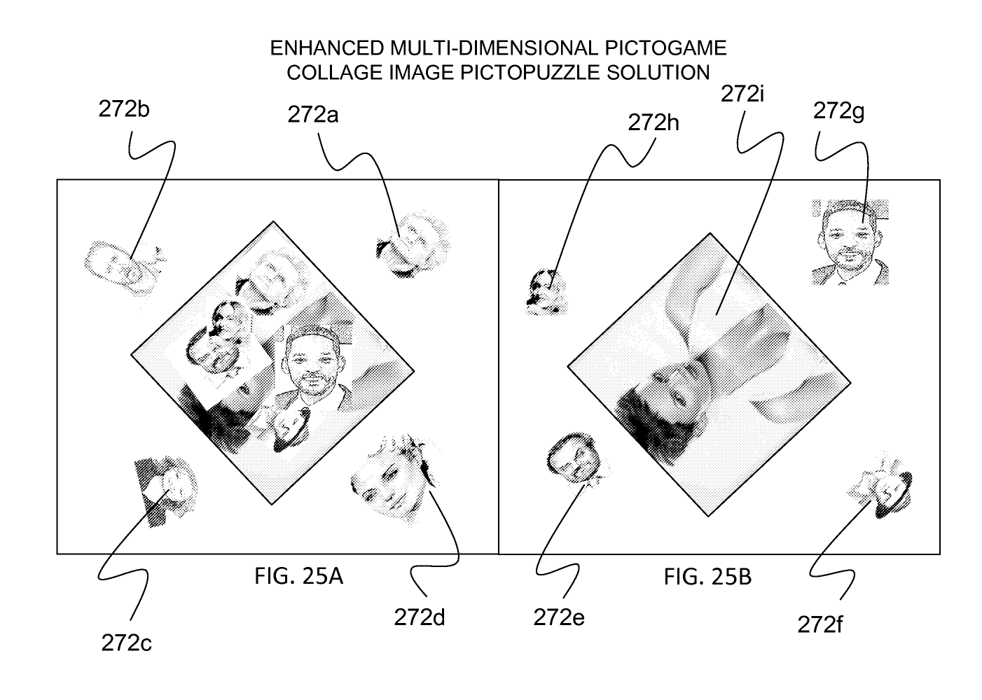

As an example, shown in FIG. 24, the Collage Image 271 of the PictoPuzzle 270 may display pictures of well-known personalities and a selection must be made of the correct personality that performed in a specific movie, or who authored a specific book, or who landed on the moon, or any other variety of trivia questions that require the input of a correct answer by selecting the correct character to remove the PictoLayer. A correct answer and the next Challenge 257 related to the PictoPuzzle images may be presented. In this example, the Challenge 257 is in the form of a trivia question; “This actor has a famous actor father who was nominated for three Academy Awards?” By removing the PictoLayer 272a with the image of Michael Douglas the next Challenge will be presented. As shown in FIGS. 25A and 25B each correctly answered Challenge 257 reveals more of the PictoLayers 272a-272h underneath until the base PictoLayer 272i is reached revealing in this example a picture of Halle Barry.

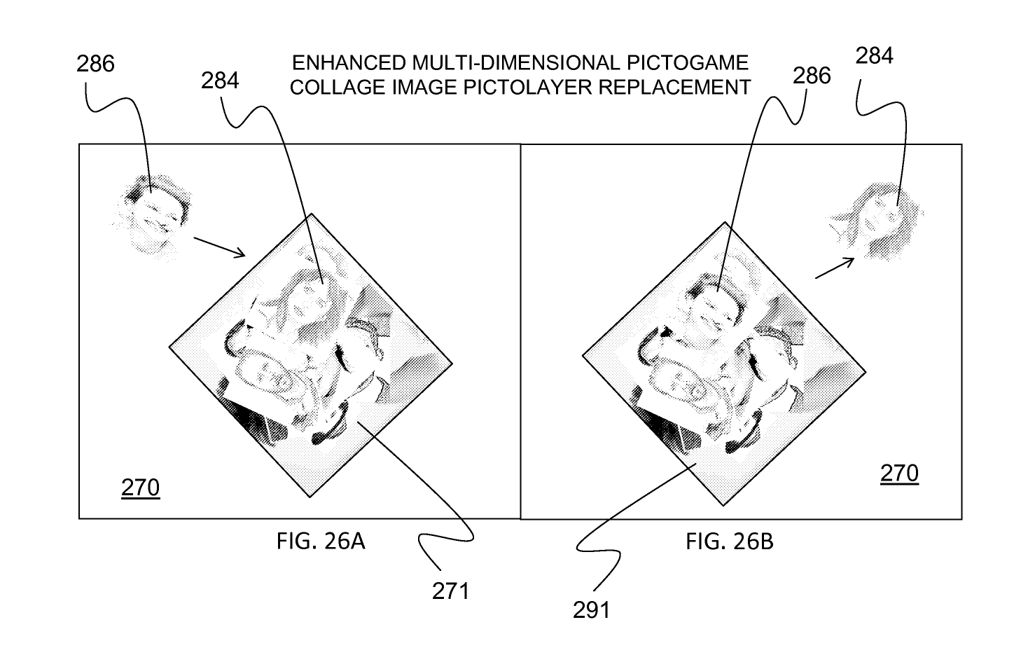

As an example, shown in FIGS. 26A and 26B, the Interchangeable PictoLayer 284 that represents an image of Penelope Cruz may be replaced with the Alternative PictoLayer 286 representing an image of Julia Roberts and changing the Collage Image 271 to a new Collage Image 291 within the PictoPuzzle 270. The replacement is seamless where the Interchangeable PictoLayer 284 is immediately replaced by accessing and re-naming the Alternative PictoLayer 286 with the Coordinate File Name matching the grid position of the Interchangeable PictoLayer 284 within the GameBoard Blueprint 30 and moving the Alternative PictoLayer 286 into the Output File Folder. The Collage Image 271 is immediately changed to Collage Image 291 and Enhancements associated with the Alternative PictoLayer 286 are immediately activated and accessible to the End User. The complete operation may occur while the PictoPuzzle 270 is being played, in this way creating an infinitely variable visual displays and Challenges 257 within the PictoGame.

### SRP Application

### Creating the PictoKids Adventure Presentation

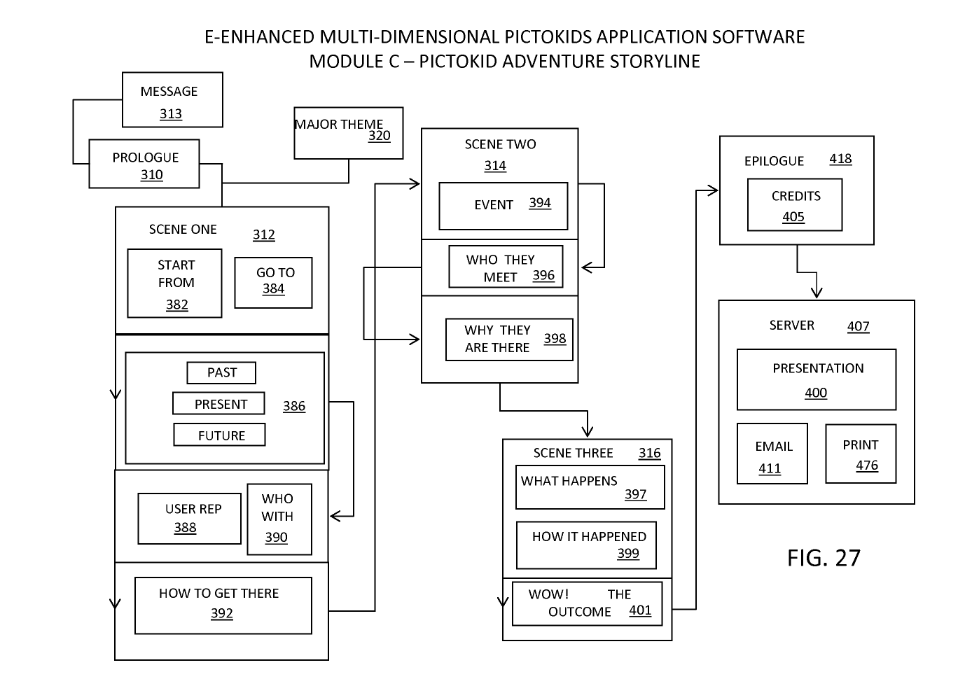

As another example of a SRP Application that may also be developed using the STAR-RAID-POINT Development Software 10 and played using SRP Core Application as a SRP Dependant Application within the Resident Server, the SRP PictoKids Software Application guides a user through a series of options to create a Multi-Dimensional PictoKids Adventure Presentation 400. The SRP PictoKids Software Application provides to a user a layout of the storyline for the PictoKids Adventure Presentation 400 that in a first embodiment includes a Prologue 310, a First Scene 312, a Second Scene 314 and a Third Scene 316 and an Epilogue 318 as shown in FIG. 27. The PictoKids Adventure Presentation 400 begins with a Prologue 310 that includes a title for the presentation, a title page with an image selected by the User or developed from the PictoStorys 347 by the Storyline Generator 324 for the Presentation 300, and an introductory message 313 that may be recorded by the User. The Scenes and Part Scenes of the PictoKids Adventure Presentation 400 are presented in the Theme Choice Montage Pages to lead and direct the User to choose the sequence of images that must be made to create the PictoKids Adventure Presentation 400.

In this example, in creating Scene 1 312, the User may first choose a Major Theme from a Theme Choice Montage Page 320 that presents pictures for an adventure entitled “(Enter User's Name) Takes a Trip”. The User is then presented with a series of pictures of possible destinations for a trip and as a Theme Sub-Topic chooses a picture representing what type of character the User will be on the trip. The Image Selector Montage Pages 320 are then structured and presented in the format of the Scenes and Part Scenes with a first Page directing the User to select where the PictoKids Adventure will Start From 382, a second Page directs the User to select an image of where the characters will Go To 384. The next Image Selector Montage Pages 320 within the formatted sequence directs the User to choose when the PictoKids Adventure takes place whether it happens in the Past, Present or Future 386. The User is then directed to choose from a series of the Character Montage Pages, a User Character 388 from the images that will represent the User in the PictoKids Adventure and a Companion Character 390 that goes with the User Character 388 on the PictoKids Adventure. The PictoKids Application Software provides features for the User to upload images of themselves and their friends to be incorporated and be used, so they may select these images or upload an image of favorite actor to select each of these images to become characters within the PictoKids Adventure Presentation 400. The final requirement for Scene 1 312 is the direction to the User to select How They Get There 392 meaning to the destination location in the PictoKids Adventure.

In Scene 2 indicated as 314, the User is directed by the PictoKids Application Software to select an image that represents the context of where they are going to, such as an Event 394 or location that provides the significance of the journey in the Adventure. The User is then directed to select from the Character Montage Page an image that represents one or more characters 396 that the User meets at the event 394. In the final Part Scene in Scene 2 314 the User is directed to select an image representing the reason Why 398 the Characters 388 and 390 have come to the event.

In Scene 3 indicated as 316, the Image Selector Montage Page displays a series of images related to the selections made by the User in Scenes 1 and 2 and that conform to the Scenes and Part Scenes formatted by the Storyline Generator. The User is directed to select an image that represents What Happens 336. The User is then directed to select an image from the Image Selector Montage Page that shows How the Action Happened 401, and then images that represent the Wow! 403; meaning the result or outcome of what happens in the PictoKids Adventure. The User selects from these Image Selector Montage Pages the what, how and outcome of what happens in the PictoKids Adventure. In the Epilogue 418, the User may provide a final message and may select an image for the finale page. They may also enter their name to be displayed in the Credits 305. The User's selections are then downloaded to a server 407 using an internet connection and are stylized, sequenced and enhanced into a series of PictoStorys to create the PictoKids Adventure Presentation 400. Using the Production Presenter Tools, the Presentation is available to the User for viewing or emailing 411 or printing 476 any portion of the Presentation.

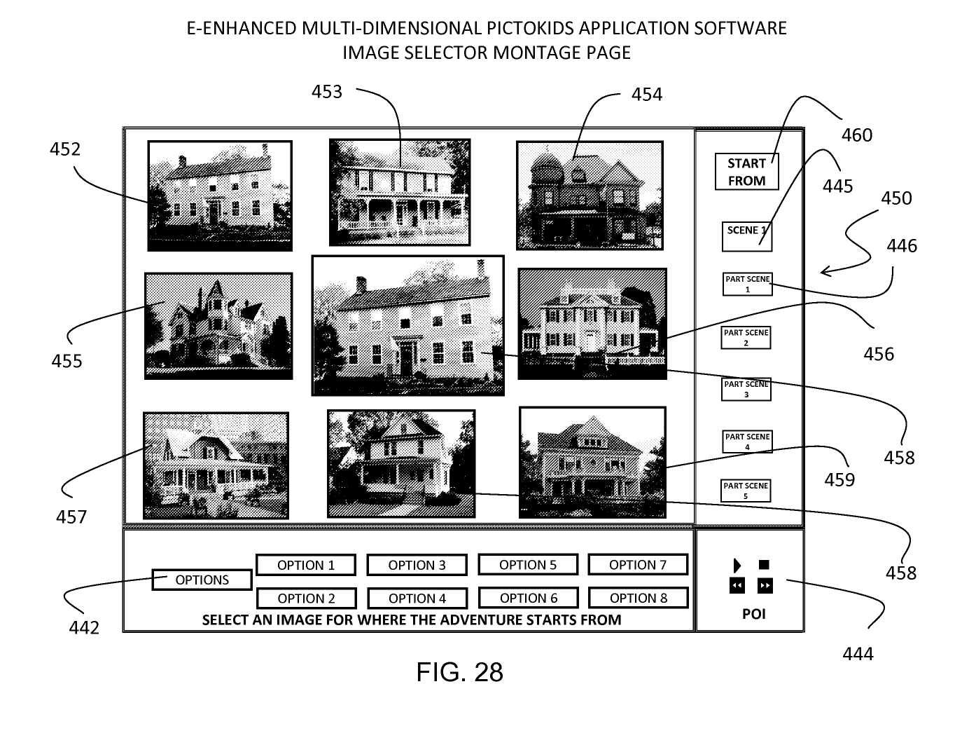

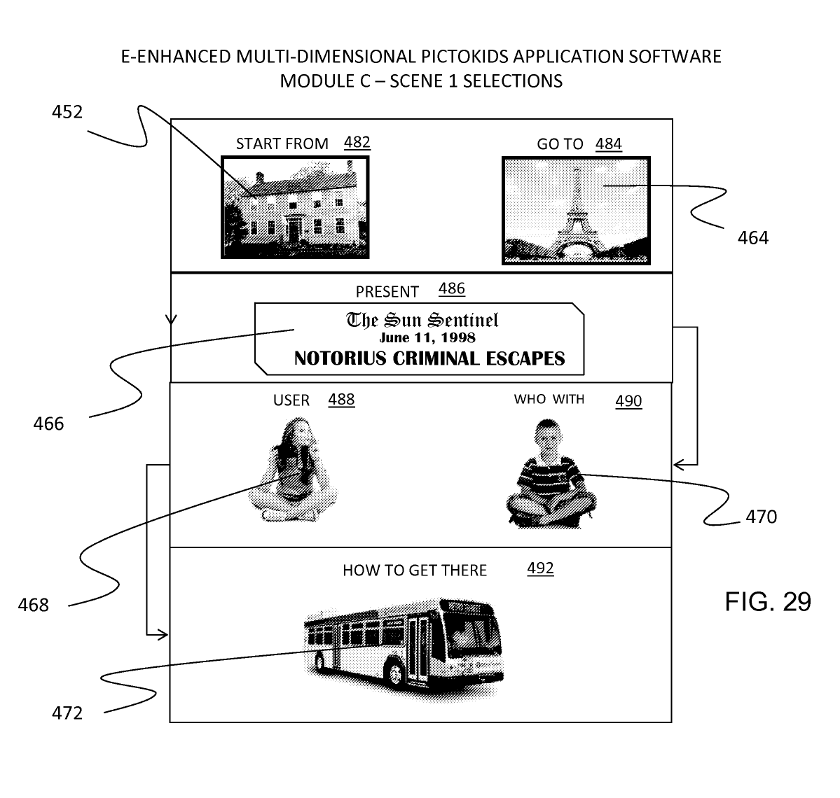

The Major Theme Choice Montage Page provides a broader scope of options that when chosen opens a narrower range of options that are displayed in subsequent Theme Sub-Topic Choice Montage Pages. These choices are structured behind the scenes using the Storyline Generator 24 into the Scenes and Part Scenes that will make up PictoKids Adventure Presentation 400 and are used to develop the Montage Pages that the User will choose from to create the Presentation 400. As shown for example in FIG. 28 as a first embodiment, the User is directed to make a first selection of where the PictoKids Adventure will Start From 482. The Image Selector Montage Page 450 shows a number of different images of houses for the User to select for where the adventure starts from. The houses are indicated as house 452-459. The Image Selector Montage Pages 450 includes a Scene Title Indicator 460, the Scene Indicator 445 and the Part Scene Indicator 446 and Option Choice Buttons 442 for the User to select where the adventure will Start From 482. As an example, selecting the House image 452, for the “Start From” 482 opens another Image Selector Montage Page that will direct the User to select from the displayed images of places where the PictoKids Adventure will go. The place in this example is Europe and as shown in FIG. 29, an image representing Paris 464 is selected by the User.

For the additional requirements to complete the information needed by the PictoKids Software to create the PictoKids Adventure Presentation 400, the User is directed to select an image that represents when the PictoKids Adventure will take place. The images within the Theme Choice Montage Pages represent the past, present and future and the User is directed to select an image displaying a current Newspaper clipping 466. Based on these selections a series of Character Image Selector Montage Pages 435 are displayed that present a series of images that direct the User to select the character they would like to represent themselves in the PictoKids Adventure. If the User selects an uploaded image of themselves the image is displayed within the Character Image Selector Page 435 to be used in the PictoKids Adventure. The Character Image Selector Pages 435 are then presented to direct the User to select who they would like to have accompany them on the PictoKids Adventure. The displayed images are related to various characters, occupations and roles that relate to the type of character chosen as the Theme Sub-Topic. For example, for the Major Theme choice of Europe, and the Theme Sub-Topic choice had options related to characters that travel such as 1. A Traveler, 2. An Explorer, 3. A Designer, 4. A Reporter, 5. A Bounty Hunter, 6. A Famous Person, 7. A Photographer, and 8. A Producer.

In this example, the type of character chosen as the Theme Sub-Topic is a photographer so the Character Image Selector Montage Page 435 provides images of photographers for the User to select. The eight images within the display may be of men, women or children and may also include images that are uploaded by the User of themselves or others to be in the PictoKids Adventure. By selecting the PictoKids Characters, the Architectural Blueprint 12 is populated with the image representing the character associated with the User 488 and with the second image representing the character selected as the Companion Character 490. The User Character 488 and Companion Character 490 images for example are shown. Scene 1 is completed with a display of an Image Selector Montage Page that directs the User to, in the final selection, select How the Characters travel 490 from the Start From location 482 to the Go To location 484 and in this example, the User selects a mode of transportation of a Bus 472. Importantly as each selection is made the Choice Generator 22 structures a second series of Image Selector Montage Pages for the next selection that is based on the previously selected images and fulfills the requirements for the types of images needed in the Scenes and Part Scenes of the storyline.

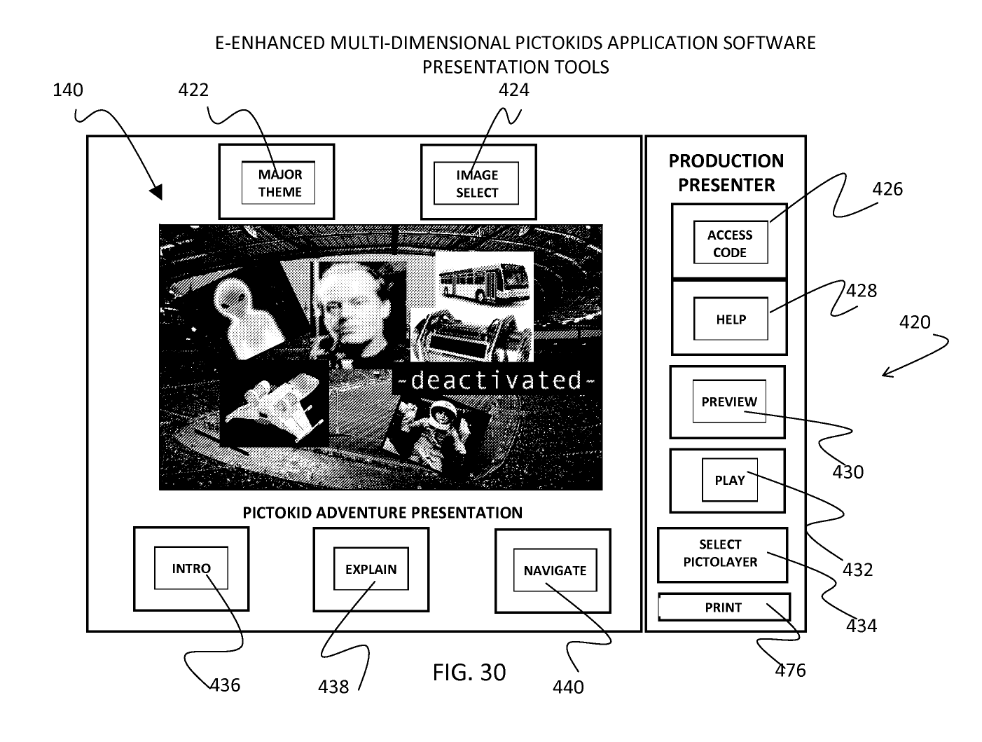

The User's selections are dynamically transformed into a PictoKids action-packed, Multi-Dimensional Show Not Tell PictoKids Adventure Presentation 400 using the SRP PictoKids Application Software. The Presentation intrigues, entices, entertains and uniquely pictorially presents the user selections. As shown in FIG. 30, the Production Presenter Display 420 provides control tools to the User to play and review the completed PictoKids Adventure Presentation 400. In this example, the User selects from images of Aliens a hero to swoop down and save everyone from a mad man who has placed a bomb at a World Cup Game. For a final scene of Wow!, the User selects a rocket ship from images of rocket ships from an Image Selector Montage Pages. The User's selections are transformed using the SRP Core Application 160 into a series of PictoStorys 34 that show the alien deactivating the bomb and defeating the criminal mastermind. For the final scene, the User 268 is shown in a spacesuit going for a ride on the friendly alien's spaceship. The Display 420 provides access to Major Theme Montage Pages 422 to create further presentations and Image Selector Montage Pages 424 to change selected images within the Presentation 100. An option 426 to enter an access or transfer code to increase PictoCash, time or points as described herein is also provided with a Help Option 428 to assist a User. A Preview Option 430 allows a User to view a partially completed or portions of a presentation. A Play Option Control 432 and Option Buttons to view the Instructional Presentations are also provided.

On completion of the Presentation 400, the User may add a message to the Epilogue 418, or a picture and signature of themselves in the credits and email the Presentation to a loved one. The Presentation 400 may also be submitted to a competition to obtain more PictoCash, or minutes, or points by comparing the Presentation with other uniquely created PictoKids Adventure Presentations 400. PictoLayers from the PictoKids Adventure Presentation 400 may further be printed on transparent sheets to form layered Collage Images. Using the Production Presenter Tools, a User may choose any portion of the Presentation and select any single PictoLayer 44 or group of PictoLayers 44 to print to create artistic Collage Displays or Cutouts of characters or things in the Presentation. The Cutouts may be printed on paper, transparent sheets, sticker labels, pre-cut Avery labels, fabric or other material that may be adhered to a fabric fastener such as Velcro, or to magnets. The cutouts may be mounted and displayed on a fabric fastener or magnetic Display Board that includes digital speakers that may be networked through a LAN or wireless connection, and that may receive the sound, narration and sound effects from the PictoKids Adventure Presentation, or provide background music or other sounds for the User to listen to while creating their Collage or pastiche artistic creations from the PictoLayer Cutouts. The Display Board may be assembled from PictoKids components or building blocks to change the size and shape of the Display Board to suit artistic creations of different size and complexity. In an embodiment, the Display Board screen may be enlarged as needed for a larger work area to present the creation or be mounted or tilted to provide for accessibility for the User.

### Payment and Account Management Using SRP PictoCash Application Software

As another example of a SRP Application that may also be developed using the STAR-RAID-POINT Development Software 10 and used using SRP Core Application as a Dependant Application within the SRP Resident Server, is the SRP PictoCash Software Application. The SRP PictoCash Application Software further provides management tools for an Entity Management System to identify a device within a PictoCash Network using secure identification referred to herein as the PictoIdentity. The Entity Management System also reviews the amount of available funds within the account and administers transactions of crediting or debiting the account. The PictoCash Account is initially funded through a retail transaction performed by a network of PictoCash Retailers. The initial cash or monetary purchase is validated by the Entity Management System and is converted to an amount of PictoCash that is available to a user to purchase mini software applications, use minutes, or make retail purchases of consumer products from a group of Authorized Dealers. The Authorized Dealers may be managed through the PictoCash Entity Management System or have a separate system to offer software or other consumer products and accept PictoCash as payment for those products. Within the PictoCash Network, the PictoCash Account is specifically designed to monetize transactions involving the downloading and use of mini software applications or mini-apps, such as PictoPuzzles, PictoKids, PictoGames and other music, games, video downloadable software applications. These available products are managed and maintained by the PictoCash Entity Management System with each transaction requiring only the use of the PictoIdentity not the entering of any personal identification information, such as a login, password or credit card number.

The present invention is not designed to permit cash exchanges or the refund of cash from the account but instead the PictoCash Account is maintained at minimal petty cash levels to permit the download and use of mini-apps or other software content. Additionally, Authorized Dealers within the PictoCash Network may accept PictoCash for retail purchases of consumer products, however any such purchases including any transaction that contains personal identification information would be within the administration and scope of an Authorized Dealer, and external to the PictoCash Management Entity.

In this way, the STAR-RAID-POINT Technology provides a completely unique and secure method of performing transactions without a User having a credit or ATM card, entering personal identification information, or having a username and password to login. The secure PictoIdentity may be used to gain access to operate and use an internet or wireless connection such as to enter and play a mini-app like a PictoPuzzle or other PictoGame on a computer, cell phone, smartphone or other electronic communications device. The completely unique access and validation system may also be used to securely access a computer software program, to upload or download content from an internet website, to access an email account, to activate a mobile device, to open a lock to enter a secure location, or to perform other secure transactions all applications of which are contemplated within the scope of the present invention.

### Details of the PictoCash Network

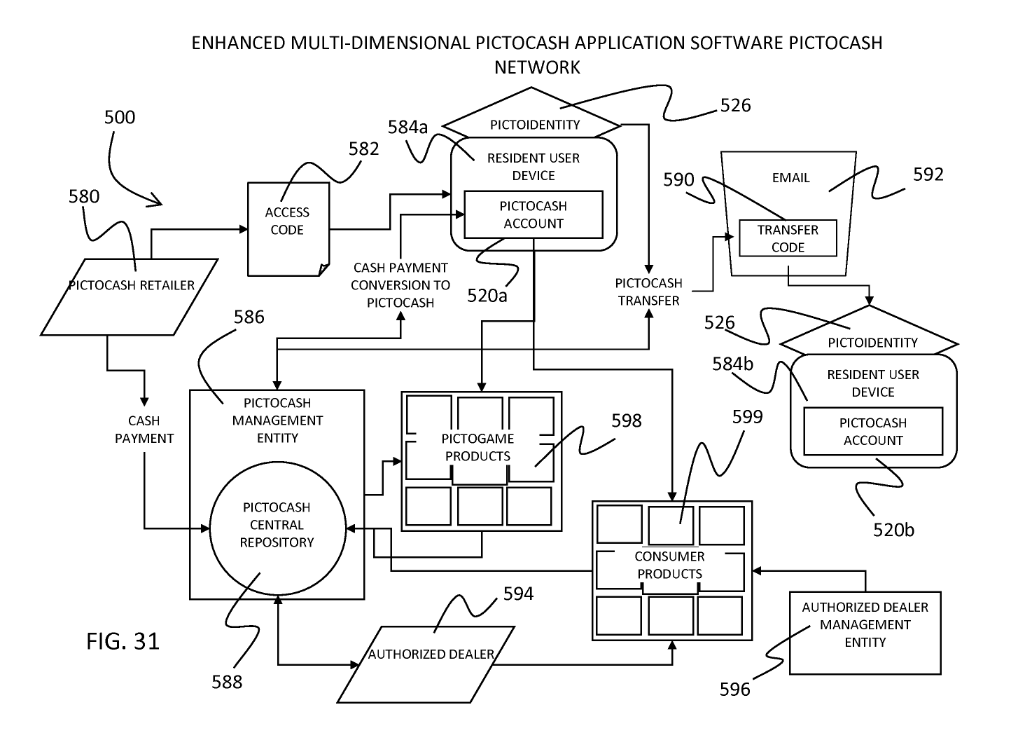

In a first embodiment, a PictoCash Account may initially be setup through a retail store purchase of an Access Code 582 printed on a receipt from a PictoCash Authorized Retailer 580 as shown in FIG. 31. As an example, the Access Code 582 may be a 12 digit number that the User enters to open the PictoCash Application Software through a local area network LAN or wireless internet connection as a resident server on a user device 584 such as a computer, a laptop, an iPod, an iPad, a tablet computer, a smartphone or other electronic device. Importantly, the Access Code 582 does not include any of the User's personal information, or any association with the User's particular PictoCash Account 520. The Access Code 582 simply provides access to the PictoCash Software Application to setup or replenish a PictoCash Account 520. Therefore, because the Access Code 582 is not associated with any personal information, the Access Code 582 if stolen would allow another User to enter the code and receive the converted PictoCash if they entered the Access Code 582 prior to the User who made the purchase. Once entered and validated by the PictoCash Management Entity 586, the PictoCash conversion and deposit is made into whichever PictoCash Account 520 a completed PictoIdentity 526 is associated with regardless if the PictoCash Account is the account of the User that made the initial retail purchase. The Access Code 582 is then invalid and blocked from reentry.

At the time of purchase as shown in FIG. 31, the cash payment minus any transaction fees is stored in a PictoCash Central Repository 588 of the PictoCash Management Entity 586 and when the Access Code is entered and validated the cash payment is converted to PictoCash and deposited in the PictoCash Account 520 associated with the completed PictoIdentity 526 of the Resident Server on the User Device 584. The PictoCash represents points or minutes or credit for the purchased cash payment that may be used to establish a starting balance or replenish a PictoCash Account 520. As described above, upon entering the software application a blank Architectural Blueprint 512 is structured and formatted for the creation of a PictoCash Account 520 on a specific Resident Server on a User Device 584. The Architectural Blueprint 512 is populated with a series of PictoStorys 534 that are created using a series of KeyConcept Querys 540 to develop the features of the PictoCash Account 520.

PictoCash funds may be transferred from one PictoCash Account 520a to another PictoCash Account 520b by requesting a Transfer Code 590 from the PictoCash Management Entity 586. The User then enters their PictoIdentity 526 to verify the transaction and the PictoCash Software generates a twelve digit code similar to the Access Code 582 that may be entered on a second Resident Server of a second User Device 584b. An Email 592 may also be sent to another User for them to enter the Transfer Code 590 into another PictoCash Account 520b. Upon request of a Transfer Code 590 the PictoCash funds are immediately transferred from the first PictoCash Account 520a to the PictoCash Central Repository 588 where they are held until the Transfer Code 590 is entered for the receiving PictoCash Account 520b. In this way, a balance cannot be overdrawn on a PictoCash Account 520, by requesting additional funds that are unavailable while a transfer is pending. Upon the transfer request the funds are immediately moved to the PictoCash Central Repository 588 and are therefore unavailable for another transaction. Upon entering the Transfer Code 590, the transaction is validated by having the User of the second PictoCash Account 520b complete their unique PictoIdentity to securely transfer the funds from the PictoCash Central Repository to the second PictoCash Account 520b.

Transactions within the PictoCash Network 500 may be performed to purchase PictoGames 598 and other software and mini-apps offered by the PictoCash Management Entity 586 within the PictoCash Network 500. An Authorized Dealer 594 may also provide other music, software or other External Consumer Products 599. PictoCash is used for these purchases with transactions performed between the PictoCash Management Entity 586 and the Authorized Dealer Management Entity 596 to accept and validate a transaction request from a User and transfer funds from the PictoCash Central Repository 588 to the Authorized Dealer 594.

### Creating the PictoIdentity

The present invention uses a completely unique approach to develop a security platform to perform a financial transaction without requiring a user to enter any personal information. The transaction may be completed on a mobile device, a computer, or other media platform. The unique security platform referred to herein as the PictoIdentity 526 may further be used to unlock a door, open a safe or gain access to another device or location. In the initial setup of a PictoCash Account 520, the User must first create a PictoIdentity 526 which the User must complete to verify and perform any transaction within the PictoCash Network 500. Importantly, in completing the PictoIdentity 526 the User does not enter any personal contact or financial information and there is absolutely no contact or financial information associated with any PictoCash Account 520 or stored and associated with the PictoCash Account 520 by the PictoCash Management Entity 586. The creation of a PictoIdentity 526 involves three steps with the User making personal choices to develop a PictoIdentity 526 that is completely unique to them.

### The PictoIdentity Alphanumeric Block

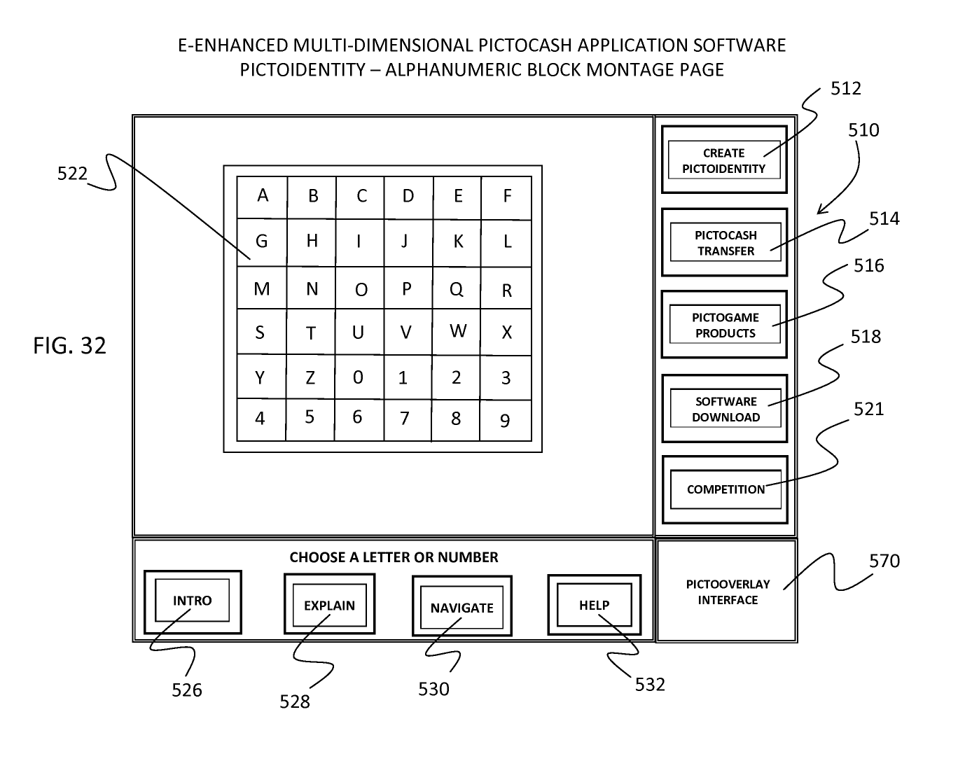

As shown in FIG. 32, in a first step, an Alphanumeric Block Montage Page 510 is created for the User to choose a letter or number to initiate the PictoIdentity 526. The choice of a letter and/or number from the Alphanumeric Block is an optional step in an embodiment of the PictoIdentity. In further embodiments, the User may begin the PictoIdentity with the choice of a Major Theme, not a letter or number. In a first embodiment, the Montage Page 510 presents the twenty-six letters of the English Alphabet and the numbers 0-9. Importantly, each Montage Page is formed from a layered Composite Image 533 made up of a series of Trans-Snips 534 in a 6×6 configuration that is formatted to be easily viewable on even the smallest cellular phone display or any mobile device that provides for User to easily choose an option from the Montage Page using a keypad, mouse touch screen or other pointer device. A chosen letter or number is indicated in the Alphanumeric Block 522 and becomes part of the User's unique PictoIdentity 526. The PictoOverlay Interface 570 may display options for the User to perform transactions such as an option to Create a PictoIdentity 512, to request a Transfer of PictoCash 514 from the PictoCash Account 520, to view PictoGame Products 516 and other products within the PictoCash Network 500, to perform a Software Download 518, to enter a Competition 520 or perform other options. The PictoOverlay Interface 570 may further provide access to view the Introduction 526, the Explanation 528, or Navigation 530 Instructional Presentations or a Help 532.

### The PictoIdentity Theme Montage Pages

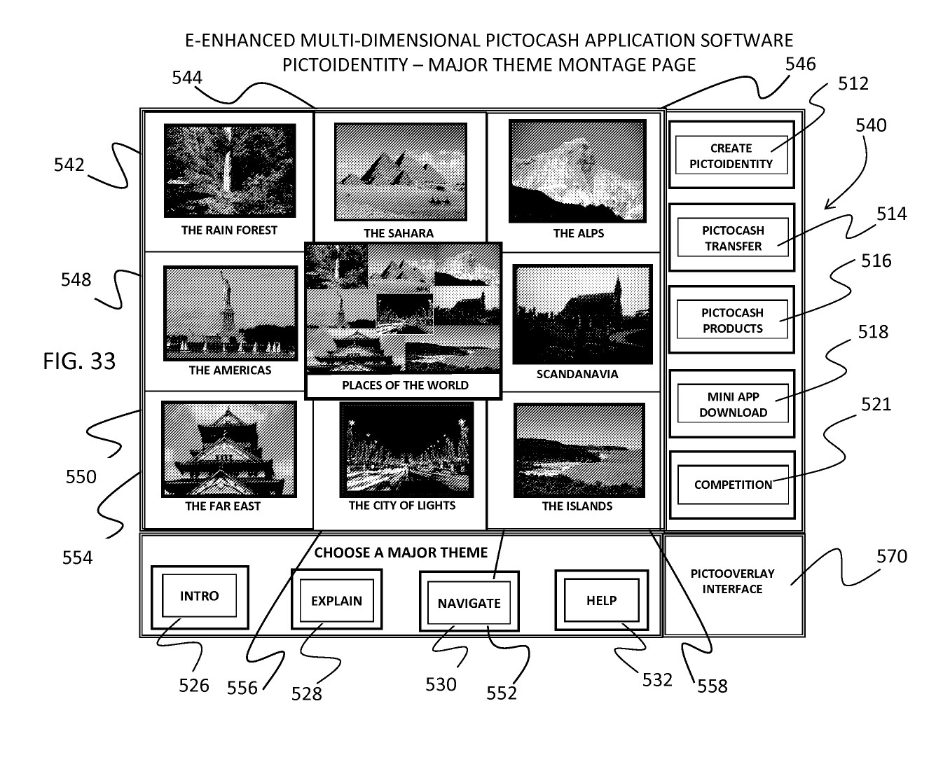

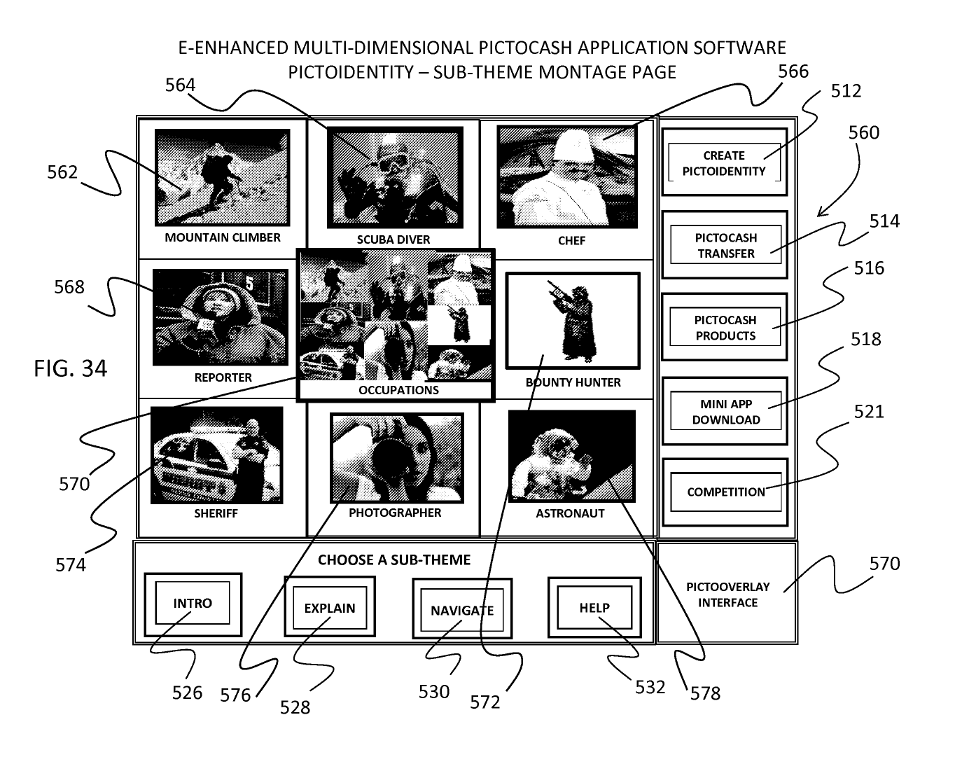

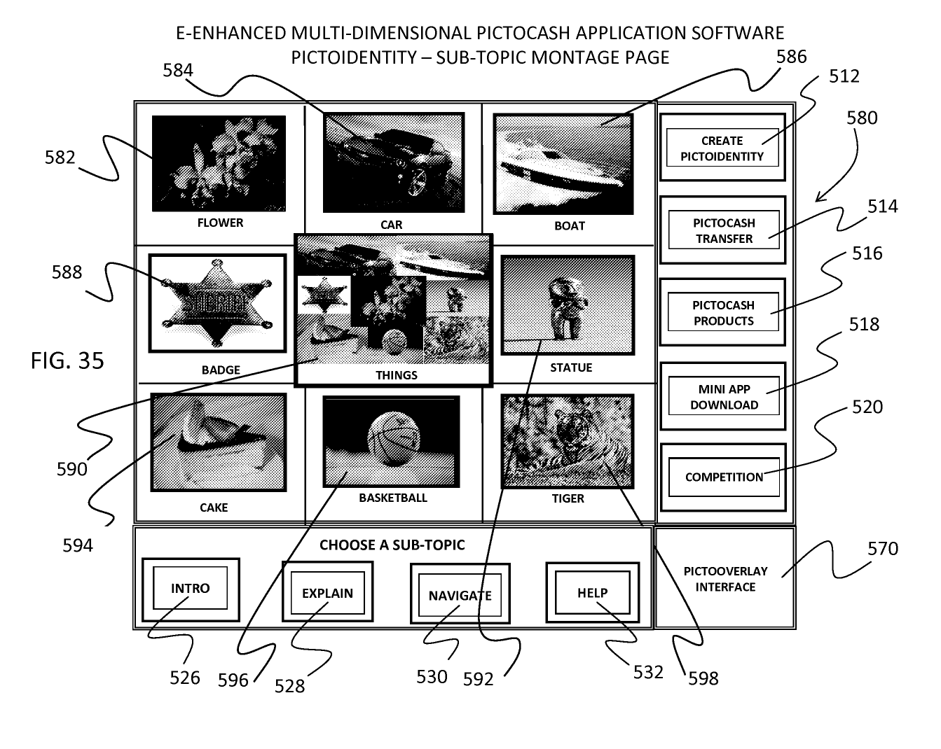

The Major Theme, Sub-Theme and Sub-Topic Montage Pages 523 are developed with a set of eight labeled pictures in a 3×3 format surrounding a center picture that is labeled as the general Theme of the Montage Page. The Theme Montage Pages 523 may be the same static pictures for all Users with each picture remaining in a static location within the Montage Page or in a randomized location with each picture interchanged around the central general them picture. In a first example as shown in FIG. 33, the general Major Theme Montage Page 540 may be Places of the World indicated in the center picture 550. The surrounding labeled pictures may display geographic locations around the globe where in this example the pictures shown are The Rain Forest 542, The Sahara 544, the Alps 546, the Americas 548, Scandinavia 552, the Far East 554, The City of Lights 556 and the Islands 558. An example of a Sub-Theme Montage Page 560 is shown in FIG. 34 with the Sub-Theme representing Occupations 570. In this example the pictures shown display a Mountain Climber 562, a Scuba Diver 564, a Chef 566, a Reporter 568, a Bounty Hunter 572, a Sheriff 574, a Photographer 576 and an Astronaut 578. An example of a Sub-Topic Montage Page 580 is shown in FIG. 35 with the Sub-Topic representing Things 590. In this example the pictures shown display a Flower 582, a Car 584, a Boat 586, a Badge 588, a Statue 592, a piece of Cake 594, a Basketball 596 and a Tiger 598. The pictures of the Major Theme Montage Page 540, the Sub-Theme Montage Page 560 and the Sub-Topic Montage Page 580 may be related in some way, such as the Americas 548, a Sheriff 574 and a Badge 588 or may have no relationship, and the User is free to choose any Major Theme picture, any Sub-Theme or any Sub-Topic. In further embodiments, any number of letters and numbers and Theme pictures may be chosen to create the PictoIdentity 526 with each choice further extending the complexity of the PictoIdentity 526. To complete the choice of a letter or number from the Alphanumeric Block 522 and chosen pictures from Theme Montage Pages 523, the User must select the Create PictoIdentity Option 512 as an example after each choice to lock each choice in as parts of the PictoIdentity 526.

Importantly, the Alphanumeric Block 522 and the other Theme Montage Pages 523 of the PictoIdentity 526 are located within the Architectural Blueprint 12 therefore include a Referenced Page Cell Map and a Referenced Page Map. The Architectural Blueprint 12 is developed using the SRP Development Software Application and is never shown to the User. However, in this manner, the actual choice by a User is designated as a location and encrypted, meaning that the actual letter, number value or chosen picture is never communicated to the PictoCash Management Entity 586 but instead an encrypted code representing the coordinates of the choices for the PictoIdentity 526 are transmitted, further preventing a hacker from determining the choices made for the PictoIdentity 526. The Alphanumeric Block 522 and the pictures of Theme Montage Pages 523 may further be presented in a randomized manner, so the User's chosen picture is still within the eight options around the center picture, but is not in the same location. A User must review and choose the correct picture for their unique PictoIdentity 526 further preventing a prying eye or hacker from determining the unique PictoIdentity 526.

### The PictoCash PictoPuzzle Generator

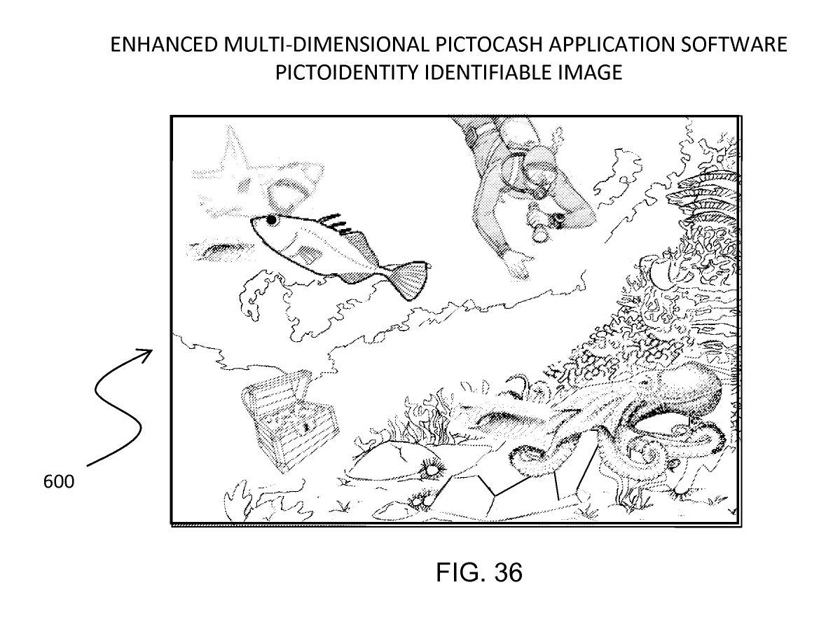

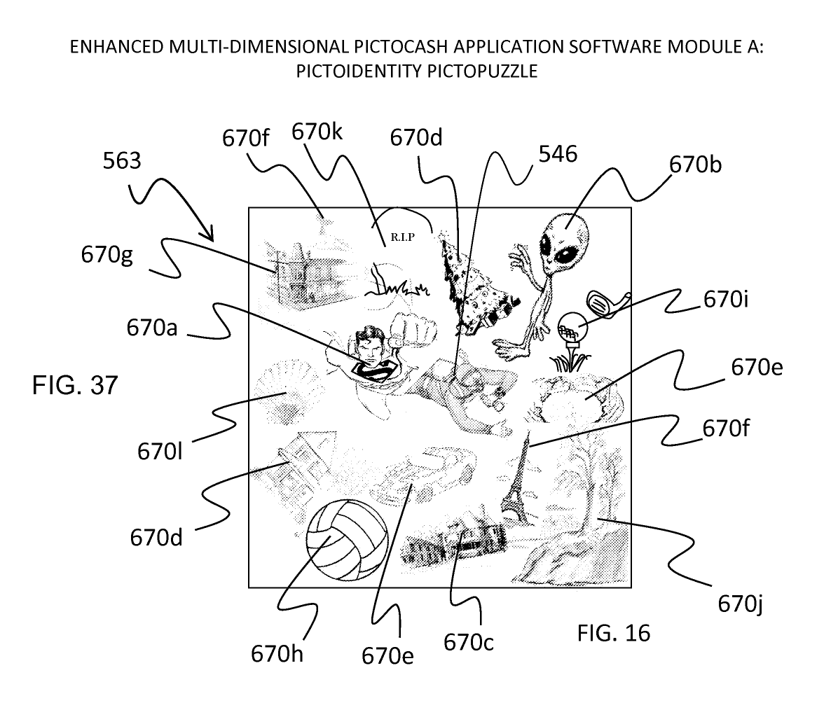

The Alphanumeric Block 522 and the Theme Montage Pages 523 are developed for the User to make choices to complete the first and second steps in the creation of the User's unique PictoIdentity 526. The final step in the creation is the selection by a User of an Identifiable Image 600 as shown in FIG. 36. The Identifiable Image 600 may be selected by the User from a series of images presented in one or more Image Selection Montage Pages that are created using the PictoPuzzle Generator 50. The PictoPuzzle Generator 50 categorizes and indexes tens of thousands of Raw Image files 76 within the Data Store Resource 48 and assembles the Montage Pages. The Image Selection Montage Page may be related to a theme or topic and display a series of images related to that topic or the Montage Page may be formed from a series of unrelated images. The User scans each image from the Montage Page and selects the identifiable image that will be used in their PictoIdentity 526 or selects an option button to display another Image Selection Montage Page to select from.

The image files that are presented within the Image Selection Montage Page are selected by the PictoPuzzle Generator 50 and are renamed using the encrypted Coordinate File Naming System based on the formatted Location Coordinate structure of the Architectural Blueprint 12. The Coordinate File Naming Structure and PictoPuzzle Generator 50 provide an index so that files of similar Components and of similar subject matter are named similarly, so that a group of related images or completely random images may be presented. These structured or randomly selected images are stored in the Data Store Resource 48 in a Variable Output Folder. Upon the option by the User to display another Image Selection Montage Page, a series of images from the Variable Output Folder are renamed with the Coordinate File Naming Structure of the Image Selection Montage Page and are copied into an Active Folder in the Data Store Resource to be viewed within the Montage Page by the User. The User may select any number of Identifiable Images 600 to be used in the PictoIdentity 526, although preferably in a first embodiment a single Identifiable Image 600 is selected.

### PictoIdentity Trans-Snip Formation

The PictoIdentity Page includes the formation of a Trans-Snip 33 from the Selected Identifiable Image 600 to be used in a PictoIdentity PictoPuzzle 563. From the Selected Identifiable Image 600 a series of Trans-Snips 33 may be formed to use randomly so that the same Trans-Snip 33 is never presented twice within a PictoIdentity PictoPuzzle 563. The Trans-Snip 33 presents only a portion of the Selected Identifiable Image 600 and therefore the User must identify the Trans-Snip 33 that represents only a portion of the Identifiable Image 600 as described herein providing for increased security, where the Trans-Snip Image 546 is not simply for example a red sports car, but is instead only a portion of the Selected Identifiable Image 600 of the red sports car that is known only to the User. In this example as shown in FIG. 36, the Selected Identifiable Image 200 is an underwater scene and a portion of the Identifiable Image 546 may be outlined and cut out and the white background of the shape cropped image may be removed from around the image and is resized to any desired dimension to be used in the PictoIdentity PictoPuzzle 526.

### Creating and Using the PictoIdentity

In order to access the PictoCash Account 520 or perform any transaction within the PictoCash Network 500, the PictoIdentity 526 must be completed to verify and confirm the User's request for the transaction. In a first embodiment as described herein, the PictoIdentity 526 is developed by the User by first deciding on a letter or number from the Alphanumeric Block 522 that may have the twenty-six letters of the English alphabet and the digits 0-9. Once the letter or number is chosen, the User may simply enter the letter or number from a keypad or touchscreen display when prompted to initiate the PictoIdentity 526. The Alphanumeric Block 522 therefore is not required to be displayed. Instead the Major Theme Montage Page 540 may be displayed for the User to identify their chosen labeled picture representing the Major Theme. The General Major Theme may be Places around the World as shown in FIG. 33 and the Chosen Major Theme may be the picture displaying the scenic vista of a sprawling beach labeled The Islands. By choosing the correct picture or by choosing the correct picture and the PictoIdentity Control Button 512 the choice may be entered. A second Montage Page is displayed showing the labeled pictures for the Sub-Theme for the User to identify their chosen picture. The Sub-Themes may show labeled pictures of people in different occupations, such as a chef, scuba diver, mountain climber and others. The User identifies their picture and chooses the PictoIdentity Control Button 512 to enter their choice. The Sub-Topic Montage Page may then be displayed with labeled pictures of different objects and the User identifies their chosen Sub-Topic labeled picture. By associating the label with the picture the chosen Major Theme, Sub-Theme and Sub-Topic may be more easily remembered with each choice being unique to the individual User.

The Theme pictures must be chosen correctly and in the correct order with each choice increasing the complexity of the PictoIdentity 526. The PictoIdentity PictoPuzzle 563 is then displayed as shown diagrammatically in FIG. 37, with the Selected Identifiable Image Trans-Snip 546 that shows only a portion of the Selected Identifiable Image 600 within a PictoPuzzle. Each Trans-Snip 670a-670k may be presented separately and appear on the screen for a short period of time such as a quarter to one-half of a second, to give the User enough time to view and identify their image and select it within the PictoPuzzle 563. The User must identify the Image Trans-Snip 546 using a keypad, touch screen mouse or other indicator to complete the PictoIdentity 526 and authorize a transaction. If for example, the User wants to purchase or continue playing a PictoGame or mini-app upon completion of the PictoIdentity 526, the PictoCash Entity Management System then transfers the appropriate amount of PictoCash out of the account as a fee for the game. Alternatively, the PictoCash Account 520 may have minutes that are transferred out of the account for each minute the User accesses the mini-app. The User is not required to do anything more than complete the PictoIdentity 526 correctly to authorize the transaction and because there is no personal information associated with the PictoCash Account, information about the transaction is also protected so no personal information is available or disclosed for data mining thereby preventing retailers from tracking, suggesting or spamming a User based on their online purchases.

A unique PictoIdentity 526 is developed by the User for each PictoCash Account 520 on a specific mobile or electronic Resident Server on a User Device 584. The unique PictoIdentity 526 may be used to access specific features within a website, view PictoCash Products 516 and complete transactions and purchases with the PictoCash Management Entity or an Authorized Dealer 594 on the PictoCash Network 500, or download or upload specific software applications 518. The PictoIdentity 526 may include in addition to the Selected Identifiable Image Trans-Snip 546, an identifying feature or image that communicates to the User the specific Authorized Dealer 594 they are purchasing from. For example, a trademark or icon from the Authorized Dealer 594 may be randomly jumbled within the PictoIdentity PictoPuzzle 563 to identify that the transaction is related to a specific retail purchase from that entity within the PictoCash Network 500. Failure to correctly complete the PictoIdentity 526 or insufficient PictoCash within the account will stop the purchase transaction or the download of a PictoGame or mini-app 518 and the User will be prompted to replenish funds in the PictoCash Account 520. The funds may be replenished through a retail purchase from a PictoCash Retailer 580 where a monetary sum is converted to PictoCash. Funds may also be accrued through the playing of PictoGames, video games or other mini-apps high scores or low scores may add or subtract from the PictoCash Account 520 either individually or in an online competition. Funds may also be transferred from one PictoCash Account 520 to another by requesting a Transfer Code 590 from the PictoCash Management Entity 586 as described herein. The Transfer Code 590 may be entered by the User on another Resident Server on a second User Device 584 that has a different PictoCash Account 520 or be emailed to another User for them to enter into their PictoCash Account 520 to transfer the PictoCash from one PictoCash Account to another. A PictoIdentity 26 must be completed to verify and confirm the transfer. Using this exclusive security protocol, the level of protection is dramatically increased over login, password or other protection systems that require the User to remember an elaborate configuration of letters and numbers or perform multiple steps and keystrokes to complete a transaction.

### The PictoCash Entity Management System

The PictoCash Entity Management System 586 manages the PictoCash Network 500 and provides PictoGames 598, other video gaming applications, music, videos and other products for a User to download or access within the PictoCash Network 500. Payment for the download or access is made using the PictoCash within the PictoCash Account 520 and each transaction is verified using the exclusive PictoIdentity 526. The PictoCash Account PictoOverlay Interface (POI) Display Screen 550, shown diagrammatically in FIG. 33, provides access to the PictoCash Account 520 with optional selection buttons to select the Instructional Presentations 528, to Transfer PictoCash 514, to view available Products 516 on the PictoCash Network 500, to Download Mini-Apps 518 and Enter Competitions 521. Performing transactions using the PictoCash Account is easy with succinct, comprehensive pictorial overviews of how to setup and use the PictoCash Account 520 from the Introduction 526, Explanation 528 and Navigation 530 Presentations. The Presentations also provide an overview of how to setup the completely unique and personal PictoIdentity 526 that may be used to perform the secure transactions within the PictoCash Network 500. To complete any purchase transaction or balance transfer, the User must enter the easily remembered and secure PictoIdentity 526 to complete the transaction. By simply performing a few keystrokes, the User completes the transaction without the necessity to remember a login name, a password of an elaborate series of letters and numbers, or have a card and read off a credit card number that may be seen or overheard. The PictoCash Account 520 maintains account balances and statements showing each transaction with each entity within the PictoCash Network 500 and provides for purchase and the transfer of funds.

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

What is claimed is:

1. A software application system for universal content display across multiple digital devices, comprising:
application software installed as a core application on a digital device on a computer system, the core application having code and content;
the application software further comprising;
an architectural blueprint;
a plurality of trans-snips within the architectural blueprint, the plurality of trans-snips forming a main panel and at least one side panel, the main panel having quadrants; and
wherein the main panel quadrants and side panel are scalable based on the display characteristics of the digital device to form a page driven, full screen display in a landscape orientation on the digital device.

2. The software application system for universal content display across multiple digital devices of claim 1 further comprising the plurality of trans-snips having variable graphics content and digital information embedded within that variable graphics content.

3. The software application system for universal content display across multiple digital devices of claim 2 further comprising a dependant application stored within at least one of a resident or an external server and having code and content; and
wherein extraction of the digital information from at least one trans-snip results in the transformation of code and content in one of at least the trans-snip, the core application and the dependant application thereby changing the functionality of one of at least the trans-snip, the core application, the dependant application and the content of the display.

4. The software application system for universal content display across multiple digital devices of claim 3 wherein the transformation of code and content results in the replacement of code and content within the dependant application without modification to the core application code.

5. The software application system for universal content display across multiple digital devices of claim 3 further comprising at least one trans-snip as variable content from the dependant application, the variable content either as an addition to the existing page driven, full screen content or a replacement or partial replacement thereof without modification to the core application code.

6. The software application system for universal content display across multiple digital devices of claim 1 wherein the universal content display presents on a single page at least a display of prior accessed content, current accessed content and optional content that has not been accessed in a before-now-after structured information format.

7. The software application system for universal content display across multiple digital devices of claim 1 wherein at least one trans-snip is enhanced and prioritized to be activated prior to other trans-snip within the plurality of trans-snips to dynamically present text, music, narration, sound effects, video, visual effects, animation, or any other supportive element associated with the trans-snip.

8. The software application system for universal content display across multiple digital devices of claim 1 wherein text is formed as a trans-snip in a graphical format.

9. The software application system for universal content display across multiple digital devices of claim 1 wherein all content within the main panel quadrants and side panel is legible and accessible by a user without scrolling or zooming across the display screen of the digital device.

10. The software application system for universal content display across multiple digital devices of claim 1 wherein the digital device is one of at least a cellular phone, smartphone, tablet computer, laptop computer or desktop computer.

11. The software application system for universal content display across multiple digital devices of claim 1 wherein the main panel is printable in landscape orientation in a standard letter size page format.

12. The software application system for universal content display across multiple digital devices of claim 1 further comprising a blueprint generator to create at least an enhanced multidimensional audio video presentation.

13. The software application system for universal content display across multiple digital devices of claim 1 further comprising a pictooverlay interface to provide for the selection of content to interact with in a video game.

14. The software application system for universal content display across multiple digital devices of claim 1 further comprising a pictopuzzle generator to create at least one of a pictopuzzle, and pictoidentity.

15. The software application system for universal content display across multiple digital devices of claim 14 further comprising a payment and account entity management system wherein purchased points are accessible to perform a financial transaction by completing a pictoidentity.

16. A method for universal content display across multiple digital devices, comprising the steps of:
installing application software as a core application on the digital device on a computer system, the core application having code and content;
forming a plurality of trans-snips;
populating an architectural blueprint with the plurality of trans-snips,
forming from the plurality of trans-snips a main panel and at least one side panel, the main panel having quadrants;
acquiring the display characteristics of a digital device and
scaling based on the display characteristics one of at least a quadrant, a main panel; and side panel to form a page driven, full screen display in a landscape orientation on the digital device.

17. The method for universal content display across multiple digital devices of claim 16, further comprising the steps of forming the plurality of trans-snips with variable graphics content and digital information embedded within that variable graphics content.

18. The method for universal content display across multiple digital devices of claim 17 further comprising the steps of installing a dependant application within a server, the dependant application having code and content; and
extracting digital information from at least one trans-snip that results in the transformation of code and content in one of at least the trans-snip, the core application and the dependant application thereby changing the functionality of one of at least the trans-snip, the core application, the dependant application and the content of the display.

19. The method for universal content display across multiple digital devices of claim 18 further comprising the steps of transforming the code and content that results in the replacement of code and content within the dependant application without modification to the core application code.

20. The method for universal content display across multiple digital devices of claim 16, further comprising the step of updating the full screen display with variable content from the resident server without modifying the core code, the variable content either as an addition to the existing page driven full screen content or a replacement or partial replacement thereof.

21. The method for universal content display across multiple digital devices of claim 16, further comprising the steps of:
associating the plurality of trans-snips with at least one enhancement to dynamically present text, music, narration, sound effects, video, visual effects, animation, or any other supportive element associated with the trans-snip; and
prioritizing the at least one trans-snip to activate the enhancement prior to the activation of enhancements associated with other trans-snips.

22. The method for universal content display across multiple digital devices of claim 16, further comprising the step of forming text as a trans-snip in a graphical format having embedded code.

23. The method for universal content display across multiple digital devices of claim 16, further comprising the step of displaying the page driven full screen display content legibly and accessible to a user without scrolling or zooming across the display screen of the digital device that is one of at least a cellular phone, smartphone, tablet computer, laptop computer or desktop computer.

24. A universally adaptable software application system:
comprising application software installed as a core application on a digital device on a computer system, the core application having code and content;
the application software further comprising;
an architectural blueprint;
a plurality of trans-snips within the architectural blueprint, the plurality of trans-snips forming having variable graphics content and digital information embedded within that variable graphics content; and
a dependant application stored within at least one of a resident or an external server and having code and content; and
wherein extraction of the digital information from at least one trans-snip results in the transformation of code and content in one of at least the trans-snip, the core application and the dependant application thereby changing the functionality of one of at least the trans-snip, the core application, the dependant application and the content of the display.
